(19) United States
(12) Patent Application Publication
(10) Pub. No.: US 2019/0005733 A1
(43) Pub. Date: Jan. 3, 2019

(54) EXTENDED REALITY CONTROLLER AND VISUALIZER

(71) Applicants: Paul Alexander Wehner, Los Angeles, CA (US); Thomas Jürgen Brückner, Karlsruhe (DE)

(72) Inventors: Paul Alexander Wehner, Los Angeles, CA (US); Thomas Jürgen Brückner, Karlsruhe (DE)

(21) Appl. No.: 16/025,271

(22) Filed: Jul. 2, 2018

Related U.S. Application Data
(60) Provisional application No. 62/527,080, filed on Jun. 30, 2017.

(51) Int. Cl. G06T 19/00; G06T 7/20; G06T 7/70; G06F 3/01; G06T 13/20; G10H 1/00

(52) U.S. Cl. CPC G06T 19/006; G06T 7/20; G06T 7/70; G06F 3/0482; G06T 13/20; G10H 1/0066; G06F 3/014

(57) ABSTRACT

A method comprises: capturing images of a movable object in a scene and tracking movement of the object in the scene based on the images, to produce movement parameters that define the movement; generating for display an extended reality (XR) visualization of the physical object in the scene and changing the XR visualization responsive to changing ones of the movement parameters, such that the XR visualization visually reflects the tracked movement; displaying the XR visualization; and converting the movement parameters to control messages configured to control one or more of sound and light, and transmitting the control messages.

### CROSS-REFERENCE TO RELATED APPLICATION

This application claims priority to U.S. Provisional Application No. 62/527,080, filed Jun. 30, 2017, the entirety of which is incorporated herein by reference.

### TECHNICAL FIELD

The present disclosure relates to extended reality visualization.

### BACKGROUND

Conventional computer input devices are limited to keyboards, 2-dimensional (2D) touch screens, and physical controllers whose look and feel have limited ability to change. In the field of computer-assisted music making, music producers and performers currently use either traditional computer input devices or dedicated music hardware like mixers or Musical Instrument Digital Interface (MIDI) controllers. These incorporate input elements like keys, rotary knobs, touch screens and the like which are attached to a more or less planar surface. This naturally limits the degrees of freedom in which these input elements can be moved and the number of parameters that can be simultaneously and independently controlled by these movements. If musicians are using these controllers while performing live on stage, it is also hard to follow what they are actually doing from the perspective of the watching audience. Additionally, for the performer, the visual feedback that they are able to receive from existing hardware is limited.

### BRIEF DESCRIPTION OF THE DRAWINGS

FIG. 1 depicts an example system architecture configured to implement extended reality visualization, including an extended reality (XR) Controller to send control parameters to and receive feedback from a bridge device or module (referred to more simply as a “bridge”), and to communicate with external entities, such as 3rd party software applications.

FIG. 2 depicts an expanded view of the system architecture.

FIG. 3 depicts another example system architecture including multiple XR Controllers that produce separate visual feeds that are sent to a feed controller, which then outputs signals to an external viewing mechanism.

FIG. 4 depicts an example architecture of the bridge.

FIG. 5 depicts a user interface of the bridge.

FIG. 6 depicts real world tracking of a physical object along an X-axis or depth of the physical object in relation to a sensor to sense position/movement of the physical object.

FIG. 7 depicts real world tracking of the physical object along an X-axis or horizontal plane.

FIG. 8 depicts real world tracking of the physical object along a Y-axis or vertical plane.

FIG. 9 illustrates the X, Y, and Z axes of a physical object within a 2D frame of view in an embodiment that utilizes a 2D field of view of a camera as the sensor.

FIG. 10 illustrates tracking depth (Z axis) of the physical object within the 2D frame.

FIG. 11 illustrates tracking horizontal position of the physical object within the 2D frame.

FIG. 12 illustrates tracking vertical position of the physical object within the 2D frame.

FIG. 13 illustrates tracking the physical object relative to a virtual 3D space, as presented to a user via an XR viewing mechanism of the XR Controller.

FIG. 14 illustrates tracking of the physical object within 3D space, where the 3D space is broken up or divided into sub-sections, e.g., quadrants.

FIG. 15 illustrates tracking the physical object within 3D space, where the physical object could pass through virtual triggers or make contact with real world triggers.

FIG. 16 illustrates tracking rotation of the physical object along the X-axis.

FIG. 17 illustrates tracking rotation of the physical object along the Y-axis.

FIG. 18 illustrates tracking rotation of the physical object along the Z-axis.

FIG. 19 shows example visualizations that could be layered on top of the physical object when viewed via the XR viewing mechanism.

FIG. 20 shows examples of how the visualization can react based on parameters derived based on movement of the physical object or from an external source, such as the bridge.

FIG. 21 shows an example of the physical object, e.g., a cube with a unique pattern on each side.

FIG. 22 shows an example transformation of the physical object into a virtual orb when viewed via the XR viewing mechanism.

FIG. 23 is an illustration of an example environment in which a camera is used to track movement of a cube to manipulate filters in an audio workstation, and simultaneously project a real world capture of the camera, and to visualize the cube as an orb.

FIG. 24 is an example projection shown in an environment in which a live performer manipulates a physical object, which is transformed into an orb for XR viewing, and manipulated in real time to control music and lighting elements of a stage show.

FIGS. 25A-25F are respective illustrations of example physical objects, which can be tracked by the XR Controller.

FIG. 26 shows an example construction used to track movement of a person, in which the construction includes a portion of a background pattern being blocked by the person.

FIG. 27 shows an example visualization including a trail of particles being left behind or trailing a physical object as it is moved.

FIG. 28 shows various logic components of a software portion of the XR controller, according to an example embodiment.

FIG. 29 is another example architecture configured to implement extended reality visualization, which omits the bridge.

FIG. 30 shows a user wearing an XR headset and viewing a cube with a unique pattern on each side as a glowing sun and, as the sun is manipulated, parameters in a digital audio workstation (e.g., Ableton Live) are correspondingly manipulated.

FIG. 31 shows how a disc jockey (DJ) appearing to hold a holographic visualization when viewed via an XR device by an audience facing the DJ.

FIG. 32 shows an alternate view of the audience from FIG. 31, where holographic visualizations, such as a glowing sun, could be viewed overhead and their movement manipulated in real-time by the DJ and the music that is being generated.

FIG. 33 is a flowchart of an example method of implementing extended reality visualization performed by the XR controller and bridge.

FIG. 34 is a block diagram of an example computer device representative of the bridge or the XR controller without the physical object.

FIG. 35 is a flowchart of an example method of implementing a control mechanism using gesture control gloves to manipulate music and extended reality visualizations.

FIG. 36 shows one form of tracking and normalization possible with a sensored glove based on the rotation of the hand, according to an example embodiment.

FIG. 37 shows one form of tracking and normalization possible with a sensored glove based on the movement of a finger, according to an example embodiment.

FIG. 38 is an illustration of XR visualizations layered on top of a (static) physical object.

### DESCRIPTION OF EXAMPLE EMBODIMENTS

### Overview

Embodiments presented herein enable one or more individuals to use movement of one or more physical objects in 3D space to control multiple external entities, including 3rd party software applications and devices, in real-time and to receive real-time XR and non-XR feedback. The system: tracks a position and a rotation of 3D objects and/or the position of a user or multiple users in space with computer vision technology or alternate positional tracking technology; interprets position and rotation of 3D objects in 3D space as a method of controlling external entities, such as the 3rd party software applications; communicates in real-time between tracking enabled computer devices and the 3rd party software applications; and provides visual feedback layered on top of real world physical objects and spaces via extended reality viewing mechanisms. Embodiments may include, but are not limited to, a controller and holographic feedback mechanism.

Non-limiting features of the embodiments include:
Music controllers that allow a producer in a studio to acquire creative inspirations by using a new way of interacting with music software.
Music controllers for live music performances that allow manipulation of audio and visual performance elements (sound, light-show, pyrotechnics, AR holograms, etc.) on stage.
Music instruments that exist purely in extended reality and use interactions in 3D space to make music.
Virtual playgrounds where children and adults can learn about music, music making, and/or music-related hardware or software (e.g., how a synthesizer works).
Interactive drawing, painting or photo-editing environments.
Interactive art for use in art exhibits.
Lighting controller for in home or venue.
Group music making experience that involves input of multiple controllers or sensors at the same time.

### DETAILED DESCRIPTION

### Definitions

Augmented Reality (AR) is an enhanced version of reality created by the use of technology to overlay digital information (visually) on an image of an object/scene being viewed through a device, such as a camera with a viewing screen. Additionally, AR can comprise the use of light-field technology to overlay light representative of virtual objects on top of real world light emissions.

Virtual Reality (VR) is an artificial environment which is experienced through sensory stimuli (such as sights and sounds) provided by a computer and in which one's actions partially determine what happens in the environment.

Mixed Reality (MR), also referred to as hybrid reality, is the merging of real and virtual worlds to produce new environments and visualizations where physical and digital objects co-exist and may interact in real time. Holograms viewed by the naked eye can be included in Mixed Reality.

Extended Reality (XR) includes AR, VR, and MR. In other words, XR represents an umbrella covering all three realities AR, VR, and MR.

### System

XR provides an opportunity for a new type of input device which can utilize movement and position tracking of “real world” physical objects in 3D space as input, and holographic visualizations layered on top of those “real world” physical objects which are manipulated and visualized in real-time to provide feedback to a user. Additional visual, auditory, haptic, and olfactory based feedback can be provided to the user via XR and non-XR experiences. Embodiments presented herein advantageously provide a combination of the XR and non-XR experiences to the user, as described below.

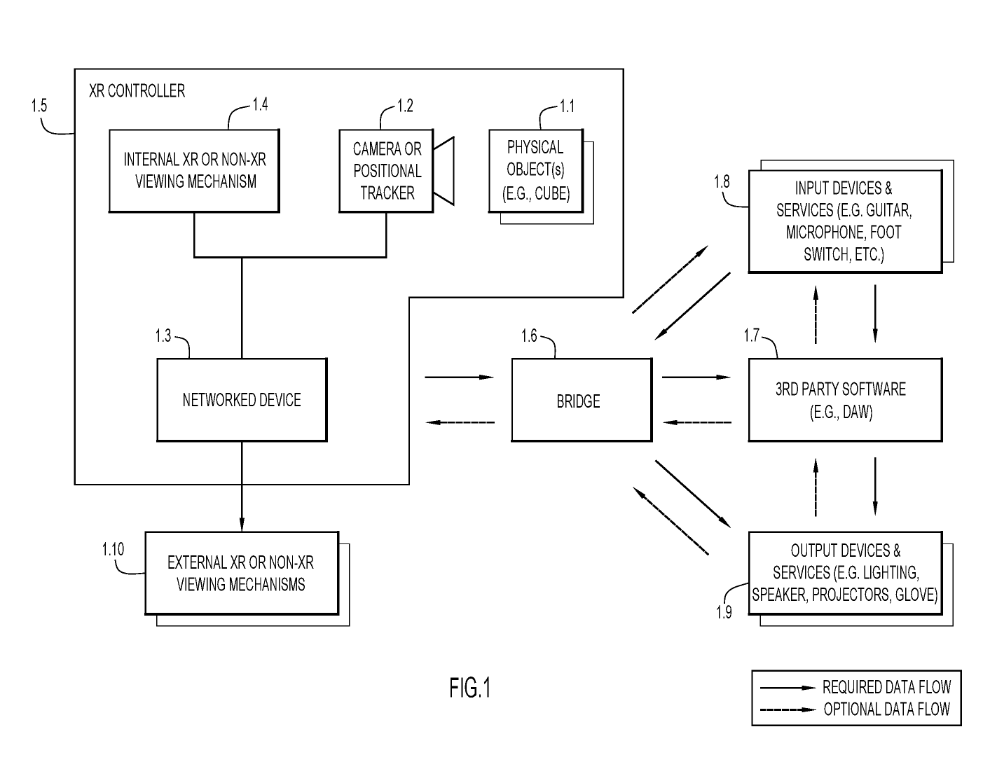

FIG. 1 shows an example system architecture for an XR controller and visualizer. The system architecture (or simply “system”) includes an XR Controller 1.5, a bridge 1.6, and 3rd Party Software 1.7. The XR Controller 1.5 sends information to, communicates with, and receives feedback from the bridge 1.6, which in turn sends information to, communicates with, and receives feedback from 3rd Party Software 1.7. The 3rd Party Software 1.7 is thus able to react and be controlled via the XR Controller 1.5 in real-time, while also providing feedback that can be leveraged within the XR Controller via XR visualizations and other means. 3rd Party Software includes any known or hereafter developed computer software, including, but not limited to, commercially available computer software, open source computer software, computer software hosted on a commercially available produce, and so on.

The XR Controller 1.5 includes: 1) one or more physical objects 1.1, which can be physically manipulated by a user; 2) a camera or positional tracker 1.2 which tracks the movement and rotation of the physical objects; 3) an internal XR or non-XR viewing mechanism 1.4, which enables the user to view an XR version of the real world, in which the physical objects are animated and visualized in the context of real or virtual worlds (or non-XR visuals); and 4) and a networked controller 1.3 which may include, but is not limited to, a mobile phone, laptop, desktop personal computer (PC) or any central processing unit (CPU)-powered XR device with networking capabilities, such as a VR headset or AR goggles/visors. For clarity, if a mobile phone were used, the internal XR or non-XR viewing mechanism may be the phone's screen, and the camera or positional tracker may be the phone's camera. Alternatively, if a laptop or desktop PC were the networked device, an internal or external monitor could be the XR or non-XR viewing mechanism, and a webcam or an alternative external positional tracker could be used.

### Tracking Physical Objects

In regards to the physical object(s) 1.1, embodiments use the movement (change in 3D position) and rotation of the physical objects in real world 3D space to produce movement parameters or signals which are sent to the bridge, and which the bridge can then convert to control messages/commands to manipulate 3rd party software and hardware. In an alternative embodiment, the movement parameters produced by the XR Controller and the physical object(s) may be sent directly to 3rd party software and hardware, without using the bridge as intermediary. Optionally, the invention also transforms the physical objects into 3D animations and visualizations that are layered into either real or virtual worlds and viewed via both internal and external XR or non-XR viewing mechanisms 1.4, 1.10 in real time. In some embodiments of the invention, additional parameters of the physical object (besides movement and rotation) might be used as well, e.g. acceleration, the geographic position of the physical object (e.g. latitude and longitude detected by a Global Positioning System (GPS) tracker), or the position inside a room detected by sensors like location beacons, gyroscopes, compasses, or proximity sensors.

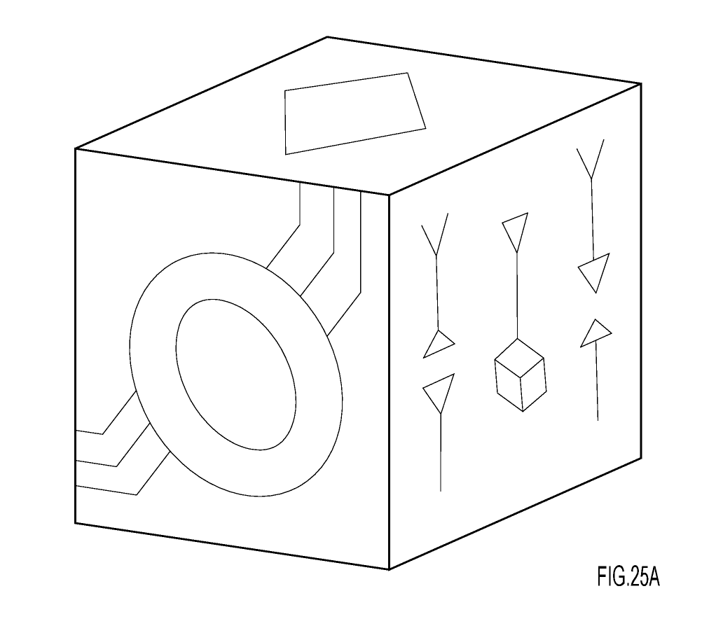

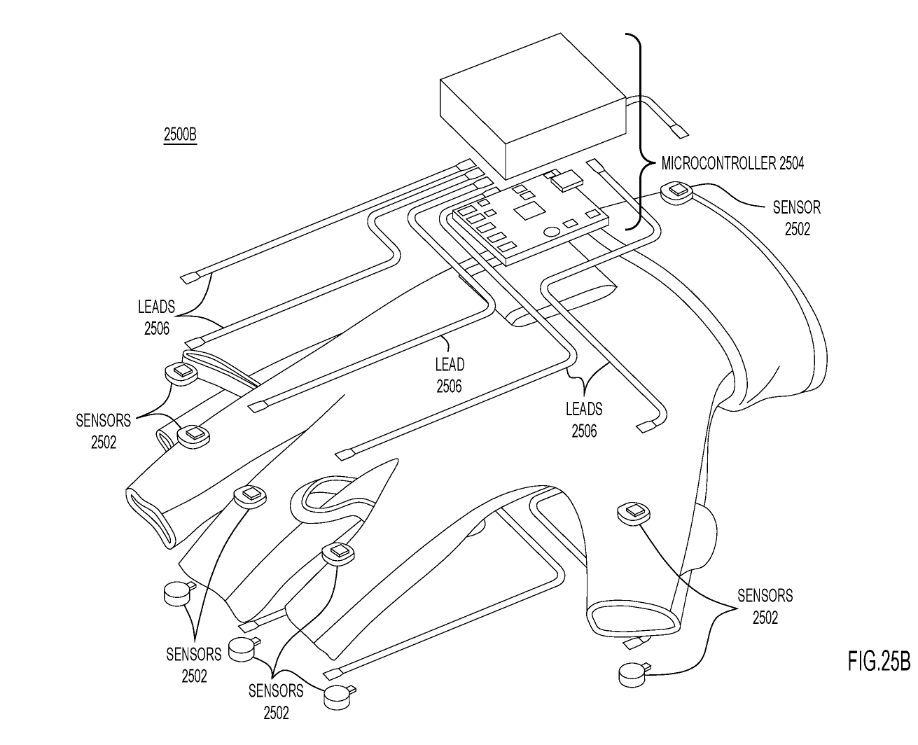

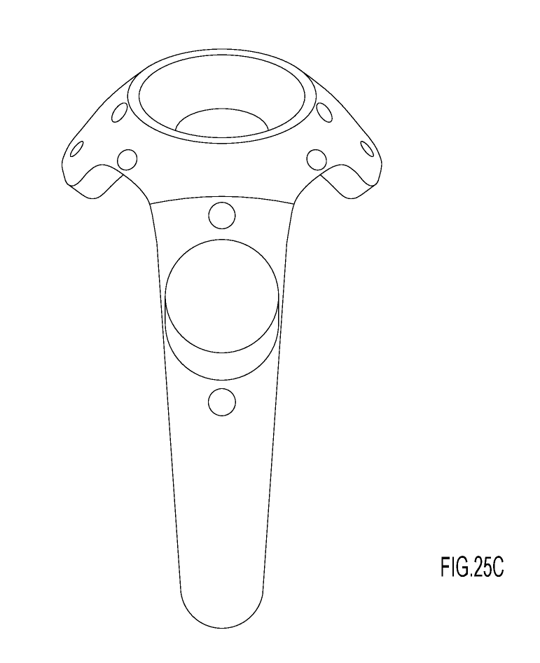

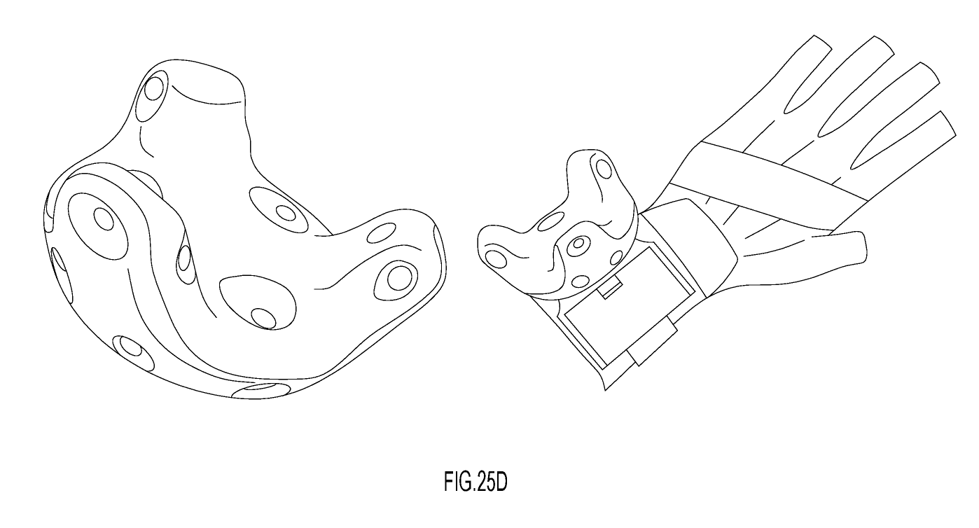

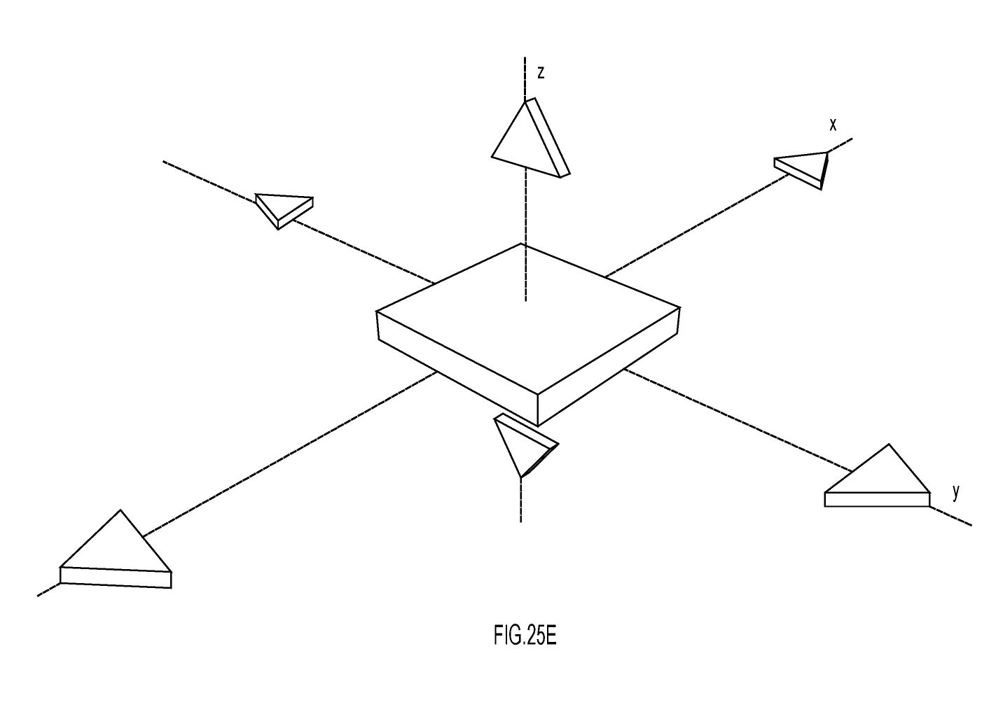

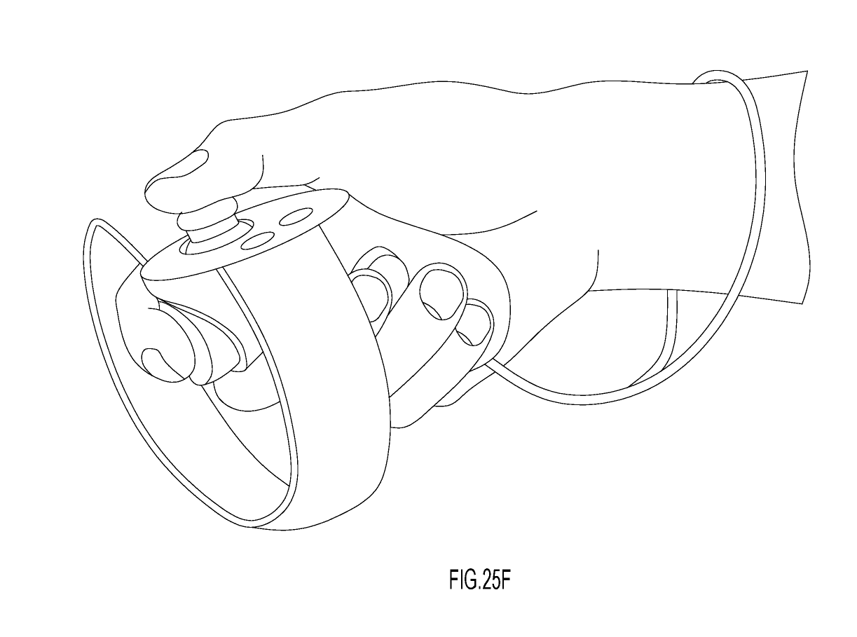

In an embodiment, the physical objects can be tracked utilizing a camera 1.2 associated with tracking logic implemented, e.g., in a controller. To assist the camera in tracking the physical objects, a unique pattern or marker is placed on each side of the physical object, so that each side is independently recognizable. Alternatively, if you only want to track one side of an object, for example a sign that is flat, a unique pattern can be placed on a single side of ab object. Alternatively, an object without distinct sides (like a sphere) may be used, where a unique pattern is layered around the object, or the shape of the object alone (e.g., a doll) could be recognizable by a camera. The physical object may be a cube with unique patterns or indicia on each side of the cube, which may be used to determine which side of the cube is facing the camera, and to determine an orientation of the cube. An example of a patterned cube is shown in FIG. 25A. The pattern is unique on each side of the cube and has a differentiated top and bottom, so that the camera and tracking logic can recognize if the object is right-side up or upside down. Thus the position of the cube may be tracked along the X, Y, and Z axes in 3D space, and rotational orientations of the cube about the X, Y, and Z axes may also be determined and tracked using the patterns. Instead of a cube, the physical object may be any of a sphere, pyramid, cylinder, as well as many other alternate shapes (including children's toys). To assist the networked device or other controller in tracking the physical object, an accelerometer or alternate tracking mechanism could be utilized. Additionally, the physical objects could be small enough to fit into a human hand, for easy manipulation, or larger, like the size of a beach ball, so that it could be passed around/amongst an audience, crowd or circle of individuals. The physical object may also be much larger than a beach ball size, so that multiple users could view the physical object via XR headsets or an XR controller as described above, e.g., as if there were a giant cube floating over an audience of 100,000 people, or a blimp or balloon in the sky. The physical object may include a piece of clothing such as a glove or full body suit imprinted with a unique pattern, so that a camera can track the physical object in the real world and layer animations on top of it. In the case of a sensored glove, additional sensors may be used as shown in FIG. 25B for precise tracking of finger and wrist movements whether the glove is on or off camera. Similarly, additional sensors can be added to the full body suit for precise tracking of body movements. Use of unique patterns that can be tracked by a camera can transform any camera enabled device into an XR Controller, such that the physical object can be tracked without additional sensors, although additional sensors could may also be used to increase tracking precision.

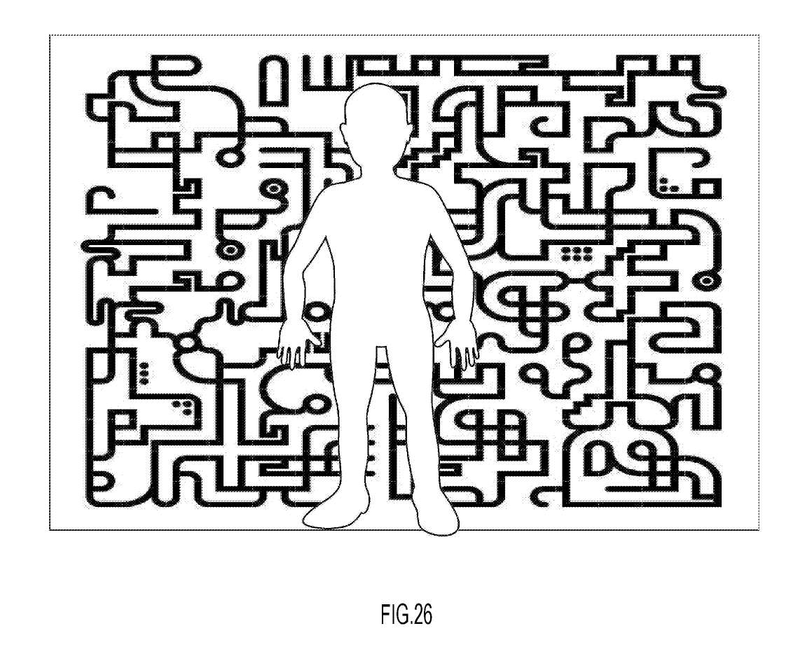

In an alternative embodiment of the tracking system for the physical object, instead of relying on the unique patterns imprinted on the physical object, a unique pattern could be placed behind the physical object or within the background of the real world, so that the physical object can be tracked relative to the background, as shown in FIG. 26, for example. FIG. 26 illustrates how a person could be tracked against the unique pattern background based on which part of the background the human is covering. Any other form of physical object could be tracked in this way as well. As an extension, even without utilizing a unique pattern background, this method could be applied by mapping, via depth and camera sensors, the layout of a room, and then tracking a person in the room as he or she moves within the context of the mapped room/landscape.

Alternatively or additionally, movement sensors can be placed inside the physical object to aid in the precision of the tracking thereof, and to collect data beyond position and rotation in 3D space. As an example, a nine degree of freedom inertial motion sensor that detects acceleration in X, Y, and Z directions, rotation about X, Y, and Z axes, and magnetic field in X, Y, and Z directions could be placed inside or on the physical object. In this example, if the internal sensor were WiFi enabled, such as an Arduino sensor equipped with WiFi, then the XR Controller may not include an additional sensor or camera to track the acceleration, movement and rotation of the physical object, and the physical object could communicate directly with either the XR Controller, the networked controller, or to the bridge. In addition to the internal sensor, a camera with tracking logic could still be used to provide the XR visualization on top of the physical object within the real world, or alternately may be omitted if the physical object was viewed in the context of a Virtual World or pre-recorded video. Alternatively, the physical object could be viewed in the context of a bridge user interface which presents a view of the physical object, in the context of other mediums and software, or not viewed at all, and may only be used as a controller without a visual feedback mechanism.

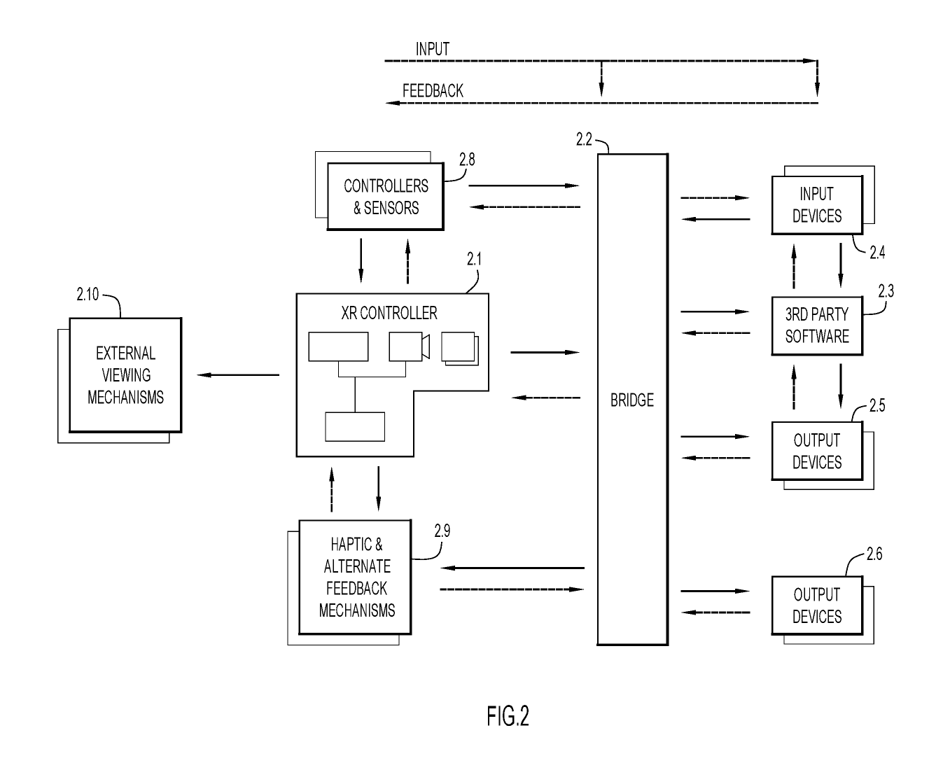

Additional examples of the physical object utilizing sensors can be seen in FIGS. 25B-25F. FIG. 25B shows an example of a physical object in the form of a sensored/instrumented, WiFi-enabled, glove 2500B to be worn on a hand of a user and that could incorporate some form of motion and position tracking for the hand itself, and motion, magnetic, touch and/or flex sensors (shown generally at 2502) for individual fingers and the hand itself (e.g., glove covering of the palm or the back of the palm). Also, the sensors may include magnets in the fingertips in concert with a magnetic sensor external to the gloves (not specifically shown but represented by the positional tracker in 1.2). Sensors 2502 provide their sensed output signals (i.e., “movement signals”) to a microcontroller 2504 fixed to the glove via leads 2506 also fixed to the glove. Microcontroller 2504 may employ logic to process the movement signals to detect (i) specific gestures, such as the hand opening and closing, (ii) specific movements of the fingers, (iii) and/or overall/generalized movements of the hands and fingers, to both specific positional and gesture control messages representing the full range of motion possible for the hand as well as to activate specific triggers, and to communicate the triggers in trigger event messages to the XR controller and the bridge. Microcontroller 2504 may transmit the positional, gesture and trigger event messages using radio frequency (RF) tag technology, as is known. If the glove is manufactured by a 3^{rd} party, and the 3^{rd} party provides software to receive the glove control messages, which software can run on a networked computing device such as a mobile phone, laptop or desktop computer. Then the 3^{rd} party software could both receive the control messages from the sensored glove, translate and normalize the control messages with some configuration options provided within the software and then communicate the positional, gesture and trigger information in the form of MIDI, Open Sound Control (OSC) or other type of control message to the bridge. In this instance the glove would be represented by “Controllers & Sensors” in 2.8 of FIG. 2. Then within the bridge, the OSC, MIDI or other form of control message can be directly passed on to 3^{rd} party software (2.3) or modified/normalized and then passed on to 3^{rd} party software (2.3), or directly passed to the XR controller, or instead modified/normalized and then passed to the XR Controller (2.1).

As mentioned above,

FIG. 25C shows an accelerometer that may be affixed to a physical object to detect its acceleration.

FIG. 25D shows a HTC Vive controller that may be used as a physical object.

FIG. 25E shows an Oculus Rift controller that may be used as a physical object.

FIG. 25F shows an HTC Vive Tracker, which could be attached to a user's wrist to be used in concert with the components shown in FIG. 25A or 25B or other types of physical objects.

The physical object is not limited to just these examples.

In another embodiment, the positional tracker 1.2 may track the physical object using “Lighthouse” tracking technology, similar to the way in which HTC Vive or Oculus Rift performs tracking. Thus, rather than or in addition to using a camera to determine where the physical objects are in XR and non-XR space, the invention could use non-visible light. “Lighthouse” boxes or base stations could be placed within a physical 3D space of a user. The Lighthouse boxes (i.e., base stations) fire out flashes of light multiple times per second and laser beams at specific timed intervals. Using light sensors on the physical object, these flashes of non-visible light and laser beams could be received by the light sensors, and the exact position of the physical object relative to the base stations may be determined based on the timing of when the flashes of light. Similarly, light emitting lights (LEDs) could be used where markers send light in different phases, for example as used in an LED based indoor positioning system by Philips Corporation.

Another alternative or additional embodiment of how the physical object is tracked could include utilizing a Kinect camera 1.2 or a similar motion sensing input device, to track the position, movements, and relative movements of a physical object in 3D space whether the object is an inanimate object like a cube or if the physical object is a person.

Alternatively, or additionally, position or proximity sensors could be placed throughout a room, and used to track movement and position, such as with “location beacons”.

In another alternative embodiment or additional embodiment of the physical object, the physical object could include a haptic feedback mechanism so that it vibrates in addition to providing visual feedback via the internal viewing mechanism, as well as other auditory and olfactory forms of feedback.

In another embodiment or additional embodiment one or more physical objects can be tracked both on and off camera simultaneously. As an example, a performer could be wearing a pair of sensored gloves (as represented in FIG. 25B as well as in 2.8 of FIG. 2 as a “Controller & Sensor”) off camera, and the XR Controller can track the sensored gloves and also two physical cubes (as represented in FIG. 25A as well as 1.1 of FIG. 1) on camera. The first cube in this example could have a distinctive set of patterns from the second cube, to make it easier to track each cube independently and to layer a distinctive holographic visual on top of each cube. For this example, the first cube can have the holographic visualization of a sun layered on top of it (although any visualization is possible), and the second cube could have a holographic visualization of an asteroid layered on top of it when viewed via the XR controller. Then as the performer makes movements and gestures with the gloves, the positional, gesture and trigger information from the glove sensors can be sent either directly to the XR Controller or to the bridge, either of which can normalize those control messages to a scale of values 0 to 1 or −1 to 1. For example, when the hand is completely open this can be normalized to represent a 0 and if the hand is completely closed, as in a fist, this can be normalized to represent a 1. This specific gesture information can be sent from the bridge to 3^{rd} party software (2.3) in the form of normalized control messages such as MIDI messages (where a 0 would represent a 0 and a 1 would represent 127). Alternatively or in addition the normalized numerical parameters could be sent to the XR Controller (2.1) and used to affect the holographic visuals layered on top the physical cubes. A message of a 0 could mean that the sun of the first cube should have a decreased luminosity and a 1 could mean the sun has increased luminosity and glows extremely bright, causing the second cube's asteroid holographic visualization to have much more light shining onto it. Alternatively, a 0 could mean that the sun visualization decreases to a minimal size to still cover the physical cube while a 1 could mean that the sun increases in size to an upper limit.

### Viewing Physical Objects and Interactions with a DAW

The XR Controller includes the internal XR or non-XR viewing mechanism 1.4. The viewing mechanism may be omitted; however, if visual feedback is desired, the viewing mechanism can provide that to the user. In one form, the viewing mechanism could be a flat display monitor like the screen on a laptop, an external monitor or projector, or the screen on a mobile device. In this instance, the screen may sit in front of and face the user, but is not directly attached to the user's head the way XR viewing goggles are. Alternatively, the mobile device could be placed in a headset, such as the MergeVR headset, Samsung Gear, or Google Cardboard to provide a richer XR viewing experience. Alternatively, the viewing mechanism could be a true augmented or mixed reality like viewing mechanism as seen on devices like the Microsoft HoloLens, Meta Headset, Magic Leap, and by other vendors, or true virtual reality viewing mechanism as provided by vendors like Oculus and HTC.

The internal XR or non-XR viewing mechanism provides direct, real time visual feedback to the user as the user manipulates the physical object(s). The viewing mechanism can display visualizations on top of the physical object layered into a real or virtual world. Those visualizations could be independent of the movements of the physical object, react directly to the movements of the physical object, or can be affected by external inputs such as from other sensors (e.g. a microphone as shown in 2.8) or from feedback parameters provided by the bridge. As an example, movement parameters indicative of the movement (3D position movement) and rotation of the physical object, as well as other parameters, can be sent from the XR controller to the bridge at or around 60 times per second. Upon receiving the parameters, the bridge could then determine acceleration from the parameters, as well as other positional, gesture and triggered based parameters. Afterwards, the bridge could convert (e.g., normalize and transform) that parameter information into MIDI or OSC control messages (or messages based on any other protocol) that are sent into a 3rd party software suite.

In one example embodiment of the invention, that 3rd party software suite could be a digital audio workstation (DAW) and, in the DAW, the MIDI messages could be tied to musical (hardware or software) instruments, filters or clips, so that music is being manipulated in real time. The DAW could communicate back to the bridge musical/sound attributes such as tempo, decibel level, time signature, MIDI messages generated by the DAW, the sound generated, and more. Then the bridge could convert (e.g., normalize) those parameters to visually renderable information (e.g., parameters that can be used to change/control visual features of the visualizations, and that represent control messages configured for controlling/changing the visualizations) and send those parameters as converted to the XR Controller, so that the internal and external viewing mechanisms can layer in animations and visualizations on top of a physical object that react in real time to the music (i.e., visual features of the visualizations change responsive to the parameters as converted). As an example, the physical object could be transformed into an orb or a glowing sun that expands and contracts to the beat, and explodes and puts out solar flares when the beat drops, and so on.

The following example assumes the size of the XR visual is to be controlled with a MIDI Control Change (CC) message, in sync with the beat of the song (pumping effect). To do this, an automation curve for the CC parameter could be set-up on a MIDI track in the DAW, where the curve is permitted to oscillate between 0 (for the smallest size) and 127 (for the largest size). Instead of using an automation curve, a Low Frequency Oscillator (LFO) can be applied to the CC parameter or use an external hardware controller, such as an expression pedal. Then, the DAW is configured to send the CC parameter value changes to a MIDI input port of the bridge while playing back the track via the DAW. The bridge receives the MIDI CC messages, processes them, and forwards the resulting processed messages to the XR controller. Message processing may comprise several steps. In one form, the messages may be forwarded “as is” (and leave their interpretation to the XR controller) or are converted to another protocol, e.g., to send them to the XR controller via a WiFi network using a network protocol such as WebSockets. Processing might also take additional steps such as normalization. For instance, the [0, 127] (integer) value range of the original MIDI CC messages may be converted to a floating point value range of 0.0 to 1.0. This normalization is particularly useful if multiple types of input message protocols (MIDI, OSC) are supported in parallel. Processing may also apply restrictions on which values are actually forwarded to the XR controller. For instance, the user could define a certain value threshold for an incoming CC parameter. If the value of the incoming CC message is above the threshold, the message is forwarded; otherwise, it is discarded. In our sample embodiment, the bridge may include a user interface that allows the user to map the processed CC message to a “resize” message that will be sent to XR controller. The software in the XR controller, used to track the movement of the physical object and derive position/size values based on the tracking, is also configured to manipulate the XR visual (i.e., control visual features of the XR visual), generated by the XR controller and overlaid on the physical object in the scene, responsive to this resize message. The software receives from the bridge the desired object size, and controls/changes the size of the XR visual so that it is representative of the normalized object size from the bridge. Thus, an increase or decrease in the MIDI CC value results in a corresponding increase or decrease in the size of the XR visual. This approach may be generalized to control different visual features of the XR visual responsive to MIDI messages that convey different musical/sound attributes, like the current tempo of the song being mapped to the color (blue means slow, red means fast) or a certain MIDI note being played triggering a “flash” effect. It may also be generalized to using other message protocols, such as OSC, or to feed audio data into the XR controller to visualize it. In another embodiment, messages indicative of movements of fingers of a sensored glove may be sent to the XR device, in order to visualize them as a “virtual hand” that moves in correlation to these movements.

In an embodiment, the XR Controller includes an internal viewing mechanism that is just visible to the user controlling the physical object, and then deliver a feed to an external viewing mechanism 1.10 which is visible to a separate viewing audience. In an example use case in which an artist or musician is using embodiments presented herein in a live performance, the internal viewing mechanism could provide additional control information and parameters to the performer so the performer can have a precise understanding of an output of the physical object(s). The performer may not want the audience to see these additional parameters, so the external viewing mechanism would not show those parameters whether the external viewing mechanism is a TV, computer display monitor, projection, Jumbotron, hologram, lighting display, water display, virtual, augmented or mixed reality display, VR, AR, MR headset or glasses based display, or some other alternate physical, haptic, olfactory, sonic or visual representation. Additionally, the internal viewing mechanism could be used without the external viewing mechanism, or vice versa, or the XR Controller could be used without either viewing mechanism. Additionally, the viewing mechanisms can display non-XR content, for example if the manipulation of the physical object was used to control the color filters on top of an image or video, where the user could see the brightness and contrast of an image adjust without a layered XR experience.

### Networked Device

The networked controller 1.3 is meant to denote a computer device which is able to communicate with other services and components over any form of network infrastructure. Example networked controllers include mobile phones, XR headsets, tablets and desktop or laptop computers, although the networked controller is not limited to these more common computer devices.

### Bridge Module Between XR Controller and 3rd Party Software

The bridge device or module 1.6 (i.e., bridge 1.6) will be described in more detail below. At a high-level, the bridge provides a mechanism for the XR Controller, as well as other sensors, controllers and devices to deliver input parameters, which can then be converted (e.g., reformatted, normalized, enhanced, limited, and so on) into control messages intended for 3rd party software, hardware, and services. The bridge may be implemented in hardware, software, or a combination thereof. The bridge may be a stand-alone component as shown in FIG. 1 by way of example, only. Alternatively, the bridge may be part (e.g., a component or module) of the XR controller, the networked device, the 3^{rd} party software, or a combination thereof.

The bridge optionally also provides a mechanism for receiving feedback from the 3rd party software, hardware and services, that could be communicated back to the XR Controller to provide real time XR or non-XR viewing feedback. An example includes a DAW (e.g., 3rd party software) sending MIDI or OSC messages to the bridge to trigger certain visual effects in the XR controller. For instance, if a MIDI “Note On” message is being sent for the D# key of the second octave, a “flash” effect is triggered on the visuals. In addition, the “velocity” of said Note On message could be used to control the intensity of the flash effect. Another example would be a DAW sending a frequency spectrum of an audio track to the bridge, which relays the frequency spectrum to the internal viewing mechanism inside the networked device (or the XR controller display) or to a DMX-based lighting system.

In order to make it easier to map message parameter values received from 3^{rd} party software to the parameter values XR effects or to parameter values of messages sent to other 3^{rd} party output software, the bridge could normalize the incoming message parameters to a certain value spectrum, like values from 0.0 to 1.0 or from −1.0 to 1.0. For instance, whereas MIDI typically uses an integer value range from [0, 127] for most of its control messages, OSC supports high-resolution floating point values. By normalizing both input parameter value ranges to a default range (e.g. floating point numbers) in the bridge, the XR controller or other 3^{rd} party software receiving bridge messages wouldn't have to care about these differences.

Additionally, the bridge can act as a “relay service” that translates messages from one message or network protocol to another. This can be useful if, for instance, a sending device (e.g. wireless sensored gloves) is connected over a WiFi network, while the receiving software (e.g. a DAW) can only receive messages via a non-networked input like a local MIDI port. In this scenario, the bridge would translate the network messages to local inter-process messages on the PC running the DAW.

Additionally, the bridge can immediately provide feedback to the XR Controller without waiting for feedback from 3rd party software, hardware and services, based on processing done within the bridge. As an example, the XR and the bridge could implement a “ping” protocol to measure the latency of the network connection between the XR Controller and the bridge. It is also possible to connect multiple XR Controllers to the bridge at the same time.

Another component of the bridge is a user interface (e.g., graphical user interface (GUI)) through which a user can specify how the bridge transforms/converts input parameters received by the XR controller, sensors, and controllers, into output control messages (e.g., sound/light control messages) and how they will be routed to the 3rd party software, hardware and services. In particular, the bridge provides a user interface that allows a user to map the movement of the physical object to output parameters. As an example, the user may decide that a vertical movement of the physical object along the Y axis controls the VCF filter cutoff frequency of a synthesizer connected via MIDI as well as the brightness of a spotlight connected via DMX as well as brightness of a XR visual such as a glowing sun layered on top of the physical object.

To support this flexible routing of input to output parameters, the bridge may support multiple software and hardware protocols (e.g. MIDI, OSC, or DMX) and also provide means of addressing multiple devices along a device chain (e.g. MIDI channels) or in another form of hardware or networking topology. The bridge may also support mechanisms for detecting these devices inside the topology automatically (plug and play, zero configuration networking). In particular, in one embodiment XR controller auto-detects an Internet Protocol (IP) address of the PC running the bridge via UDP multicast messages.

The aforementioned configurations of the bridge specified by the user (e.g., mappings) may be stored in a configuration database in local memory of the bridge or on a storage device so as to be accessible to a controller/processor of the bridge.

### 3rd Party Software, Hardware and Services

3rd party software receives bridge control messages. In one example, these control messages could be based on the movement of a physical object. In the context of a musical performance, the 3rd party software could be a DAW and the control messages could be MIDI messages. The DAW could have additional Input Devices & Services 1.8 (as well as 2.4), such an electronic keyboard or a guitar or a microphone. Thus as a band or producer is playing, the music they are producing can be fed into the DAW, and then manipulated or added to in real time based on the bridge MIDI messages, and output to Output Devices & Services 1.9 (as well as 2.5) such as speakers and lighting equipment. The same or other Input and Output Devices could be also directly connected to the bridge.

As mentioned above, the 3^{rd} party software may also send messages back to the bridge. In one example, these messages could be MIDI messages used to control the visuals displayed via the XR controller or to control the bridge setup itself. For instance, if the artist switches to another track or scene inside a DAW, a MIDI Control Change message could be sent via the bridge to the XR controller to swap out the visual as well. In another scenario, a traditional MIDI controller could be hooked up to the DAW, and the movement of a rotary knob on this controller could be used to control the rotation of the visual shown on the XR device.

Another alternative type of control message could be a Digital Multiplex (DMX) lighting message to control a DMX lighting rig. Another alternative could be JSON messages used by other 3rd party software, hardware and services, e.g. transmitted via a network protocol like WebSockets.

FIG. 2 shows an expanded view of the system displayed in FIG. 1. The top of FIG. 2 shows a high-level data flow within the system, with input starting with the XR Controller 2.1 as defined in FIG. 1, other sensors and controllers 2.8 feeding their outputs into the bridge 2.2, the bridge then optionally providing input to 3rd party software 2.3 or output devices 2.5. An example of an output device could be a lighting fixture receiving a DMX message. The feedback data flow can begin either with the 3rd party software, communicating feedback to the bridge, or alternatively feedback can originate in the bridge based on processing of input data done within the bridge. The bridge then optionally communicates feedback data to the XR Controller or to the haptic & alternate feedback mechanisms 2.9, and then the data continues to flow to the left from the XR Controller to the external viewing mechanism 2.10. One or more of the above mentioned components or data flow elements may be omitted.

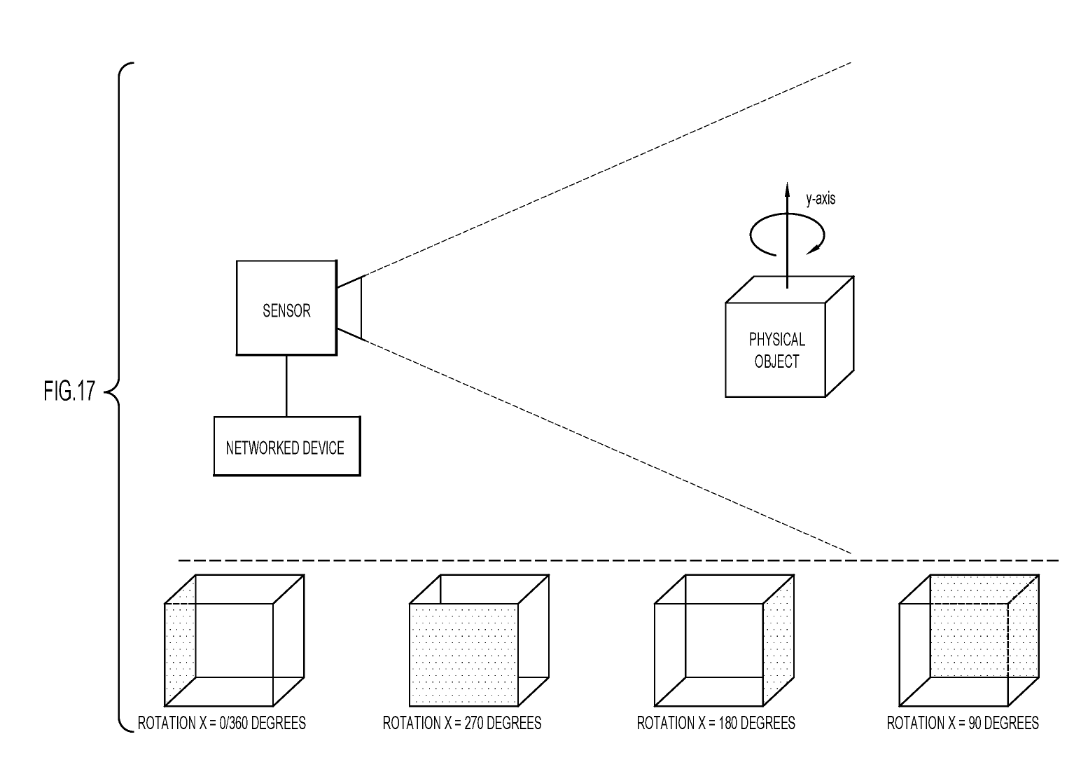

In an embodiment, the haptic & alternate feedback mechanism may react based on input directly from the XR Controller or based on input from the bridge. So, as a user manipulates the physical object(s) within the XR Controller, if for example the user hits a virtual trigger as shown in FIG. 17, the physical object could vibrate or provide an alternate feedback response related to one of the other human senses, or an external haptic or alternate feedback mechanism could react such as a rumble pack or olfactory dispenser. The haptic & alternate feedback mechanism could also react on feedback coming directly from the bridge.

Controllers and sensors 2.8 can communicate directly with the XR Controller, or can communicate directly with the bridge. Example sensors could be, but are not limited to, a heart rate monitor, 3rd party services such as a weather channel, an accelerometer, light sensors, magnetic sensors, GPS trackers, audience tracking software or hardware to determine movements, 3^{rd} party gesture control gloves or other physical movement trackers such a mi.mu gloves, MYO armband, or Leap Motion, or a PIXL device from the company Hurdl.

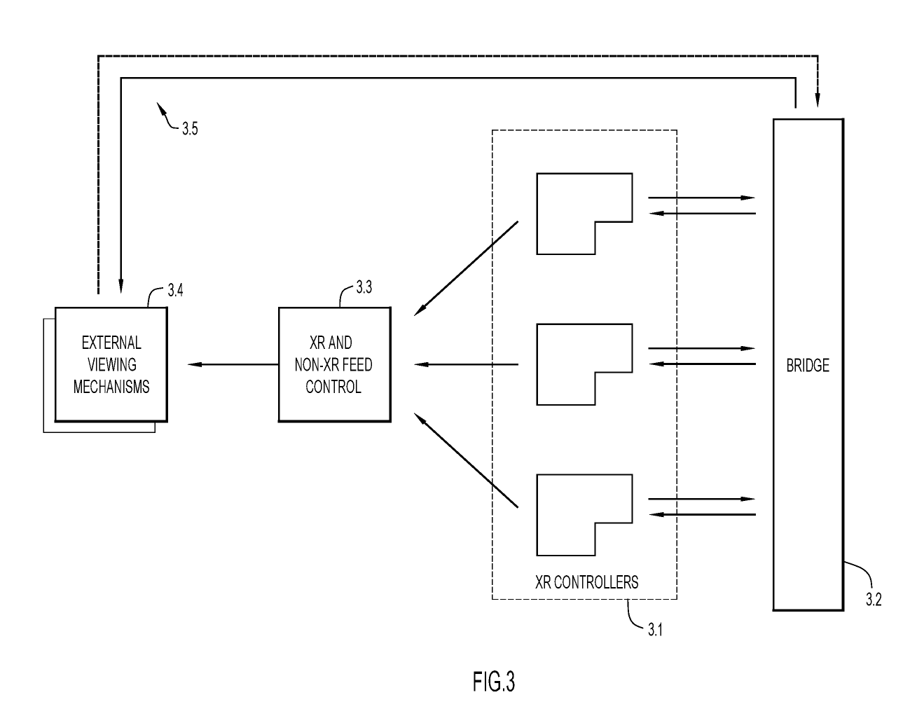

FIG. 3 illustrates an embodiment where multiple XR Controllers are used and each communicates and receives feedback from the bridge. In instances where multiple XR Controllers are used, and where any combination of the components of the XR Controller are used, each XR or non-XR feed from each XR Controller can be sent to an XR and non-XR feed control 3.3. The feed control could be leveraged during live stage performances, where a director could control which XR and non-XR feed to display to the audience via the external viewing mechanisms 3.4. This can be thought of as the control room for a newsroom where a director actively cuts between video feeds for a live broadcast, but in this case cuts between XR (or non-XR) feeds which could include like video feeds or holographic visualizations that could be placed over a live audience and be based directly on the manipulation of the physical object, or could be an alternative holographic visualization which changes based on feedback from the bridge. Additionally or alternatively, the feed may include numerical parameters, and then the visualizations and alternative forms of sensory feedback could be generated within the external viewing mechanisms based on those parameters 3.4

In an embodiment, the external viewing mechanisms could encompass displaying the XR and non-XR feed on a Jumbotron or projected to a screen in real time, where each audience member would not be required to have an XR enabled device to view the feed. Alternatively, each audience member could have an XR enabled headset, or XR enabled device such as a mobile phone, so that each audience member could see holograms displayed throughout the venue that could be pre-programmed or could react in real time based on input from the XR Controller(s) or the XR feed control, or not use input from the XR Controller(s) or XR feed control and be based on parameters that are fed directly from the bridge as shown in 3.5. XR enabled devices used by the audience might also include features that actively involve the audience in the show, e.g. by sending feedback to the artist, controlling their displays in a synced manner so the whole audience becomes part of a large visual representation, or by moving the devices around to create virtual “Mexican waves” in XR. These communal experience features might also be controlled and coordinated centrally by the bridge. This might go as far as that, in a particular embodiment, no artist is involved at all, e.g. in a club, and the audience solely interacts with each other, controlling visuals and/or music by moving on the dancefloor, flocking together, or performing other forms of collaborative actions.

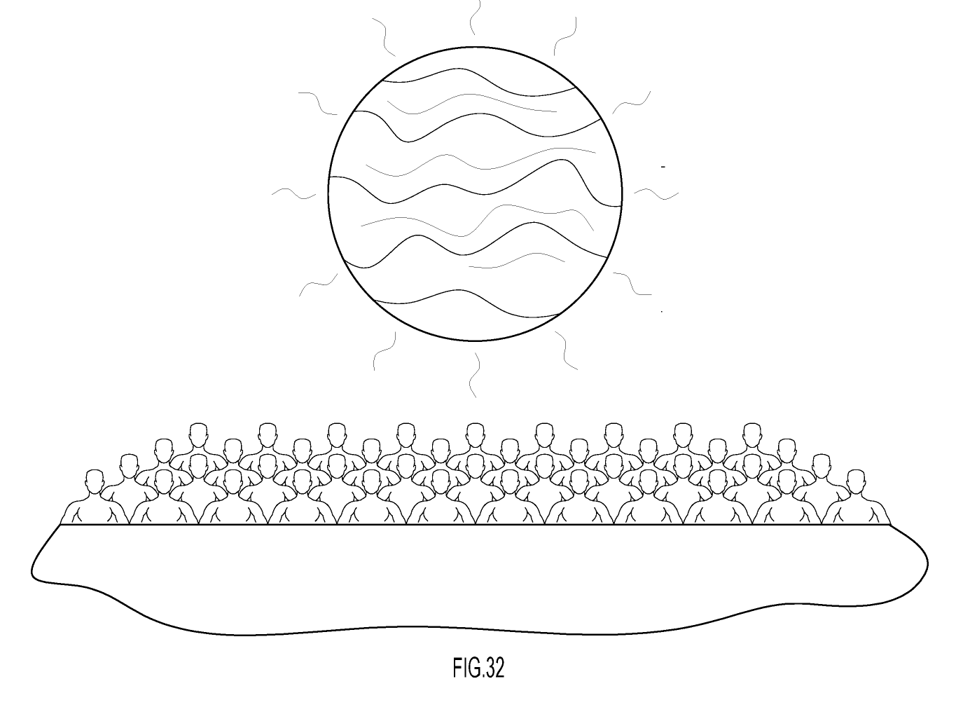

In the instance where either the bridge or the XR Controllers are sending parameters to the external viewing mechanisms, the parameters being sent (in real-time to many external viewing mechanisms) may include positional, rotational, size (as well as other parameter information). As the position Y parameter changes for example, the visual being generated on the external viewing mechanism (e.g., a glowing sun), would ascend (go up) in the sky, and as the position Y parameter decreases the visual would descend (go down). Rotational parameters would set the rotation of the visual. Size parameters could set the size. With the positional information the visual could be placed in 3D space either relative to the location of the external viewing mechanism or relative to the venue itself. If relative to the external viewing mechanism, the visual would appear in a different real world location based on the position of the external viewing mechanism within the real world. If relative to the venue, then the visual would appear in the same absolute real world position across all the external viewing mechanisms. For example if there were a glowing sun hovering over the audience as shown in FIG. 32, the sun would appear to be in the same location for everyone in the audience. So, to a person in the back of the audience, the visual (e.g., sun) would appear far away. To a person in the front of the audience, the visual and the sun have a venue relative position above the front of the audience, and would appear to be above that person.

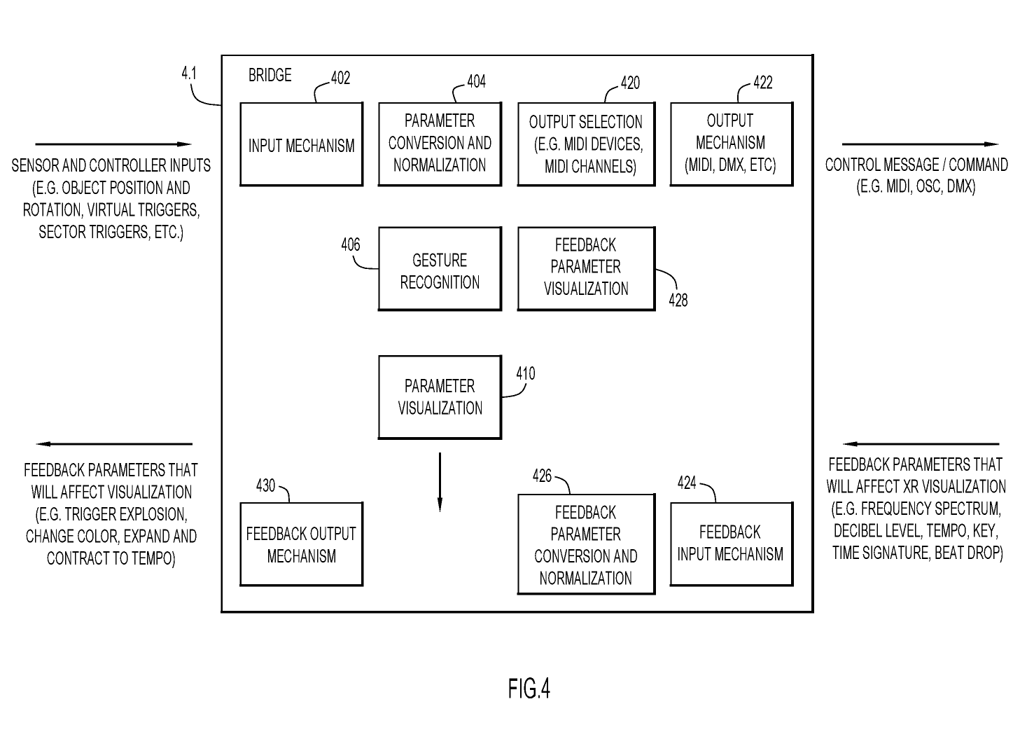

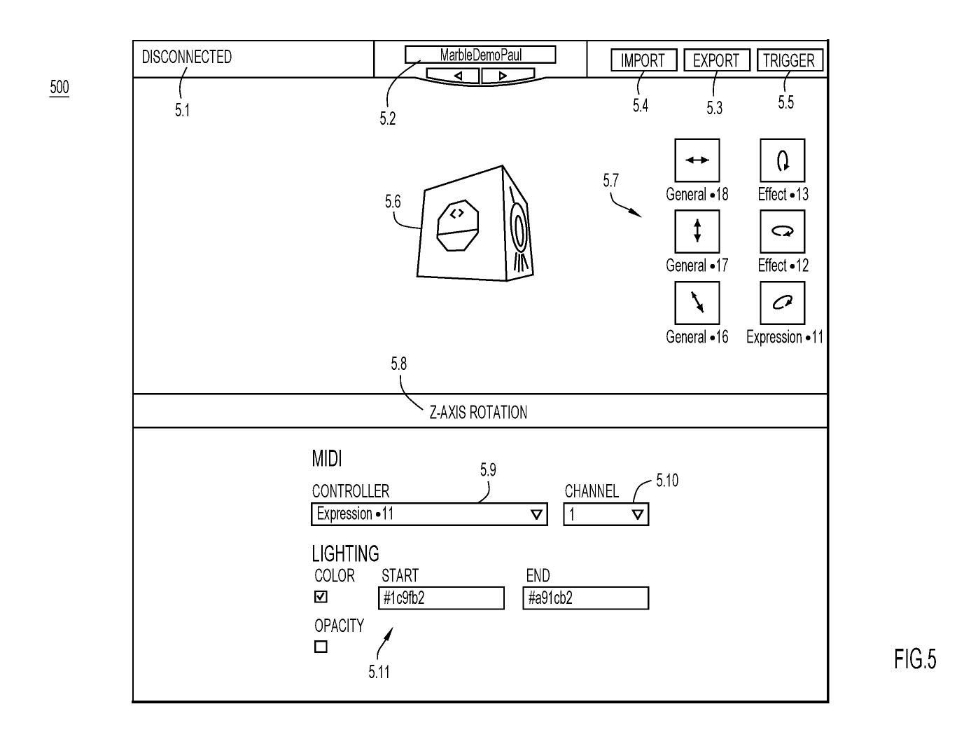

FIG. 4 provides a high-level block diagram of internal (logic) components of the bridge, and data flow into, within, and out of the bridge. The bridge receives sensor and controller inputs. These messages could be received in many different ways within the input mechanism 402. In a non-limiting example, the input mechanism 4.2 could be a Representational State Transfer (REST) endpoint or a Web Socket that communicates with a corresponding mechanism of the XR controller. When the input data is received, then parameter conversion and normalization 404 occurs on the input data. For example, acceleration of the physical objects could be detected based on changes in the X, Y, and Z coordinate data per time period. Additionally, at this stage, gesture recognition 406 could be done based on the multiple points of data being sent into the input mechanism 402 multiple times per second. The bridge user interface (GUI) discussed in connection with FIG. 5 could enable users to enter and record different parameter input sequences, and select a sequence which could then be generalized to a gesture pattern that will then be used to trigger various output, in one example. Additionally, at this stage, the incoming parameters can be visualized in a meaningful way to the user at 410, so the user can understand the input parameters, and understand and decide on the type of control messages that will be sent out to 3rd party software. Additionally, at this stage, the bridge could do internal processing based on the various input data, and then send results produced by the internal processing back to the XR Controller as well as the haptic and alternative feedback mechanism, or directly to the external viewing mechanisms.

Alternatively or in addition, after parameter conversion and normalization 404 comes output selection 420, for which the user can select what input data parameters the user wants to leverage for output control messages and then the format of the output control message. After this, the output mechanism 422 would communicate the control messages to 3rd party software, hardware and services.

The bridge also can include a feedback input mechanism 424 for feedback from 3rd party software, hardware and services to which the bridge is sending control messages, and that feedback can then be converted and normalized at 426, visualized at 428, and then communicated back to the XR Controller and haptic and alternative feedback mechanism via the feedback output mechanism 430. The input mechanism 402 and feedback output mechanism 430 may be the same component, for example a Web Socket connection that allows for 2-way communication.

In an embodiment, the bridge offers a mechanism for automatically connecting to an XR Controller if both systems are on the same WiFi network (i.e., network that operates in accordance with the IEEE 802.11 standards) via User Datagram Protocol (UDP) multicast messages (zero configuration networking).

It is implied above, but the XR Controller and other controllers and sensors are expected to send a unique identifier, so the bridge can then offer a way for the user to choose amongst them, and control how their parameters will be utilized. Controllers might also send information about the controller type or individual features they support (e.g. visual effects, physical targets that can be detected, value ranges etc.), which would allow the bridge to show a customized user interface that, for instance, allows to map the input messages of one controller to the visual effects of another.

With reference to FIG. 5, there is an illustration of an example user interface for the bridge. The bridge User Interface enables a user of the system to view and understand all the input data coming into the bridge, select what input data the user wants to leverage for (e.g., convert to) the bridge Output control messages, select the Output control messages, route them to output devices, hardware and services, save and load past configurations and settings, and, but not limited to, to understand and control the feedback messages coming from 3rd party software that the bridge communicates back out to the input data sources as shown in FIG. 1, FIG. 2, and FIG. 3. (The bridge may also use special control messages to configure input devices, so communication between the bridge and input devices may also be bi-directional. Likewise, output devices may communicate with the bridge in a bidirectional way, e.g., to send the frequency spectrum of a generated sound back to the bridge. This part of the routing is not shown in FIG. 5.)

With reference to the bridge user interface components shown in FIG. 5, graphical user interface 500 presents multiple selectable configuration elements 5.1-5.11 through which a user may specifically configure the bridge. Generally, each configuration element 5.i is user selectable, and may accept inputs/information entered by the user. Upon receiving the selection of, and the information entered into, the element 5.i, the bridge performs operations/actions to configure the bridge according to the selection and the entered information for that element.

Element 5.1 provides feedback to the user (i.e., presents to the user an indication) as to whether a particular XR Controller is connected to the bridge. Element 5.2 allows the user to switch between: 1) multiple XR Controllers; 2) multiple physical objects 1.1 within a single XR Controller; 3) multiple Controllers & Sensors 2.8 such as a sensored glove and also to name them. For example, if two physical objects are being used in the system, the user can toggle between the two objects, and manage the configuration for each independently. Element 5.3 illustrates how a configuration could be exported to a file. Element 5.4 illustrates how a configuration could be loaded or imported. Element 5.5 illustrates how the bridge can be put into a special “trigger mode,” in which it sends only one output parameter at a time to a particular 3rd party software, hardware or device. This makes it easier to set-up the receiving software, hardware or device. For instance, a “MIDI learn” feature inside a digital audio workstation (DAW) can be used to detect the data coming from the bridge and map it to hardware or software attached to the DAW. Element 5.6 provides direct visual feedback of the rotational and positional parameters of a physical object being sent in via an XR Controller. As an example, as a user rotates the physical object, that rotation is reflected in the bridge in real time.

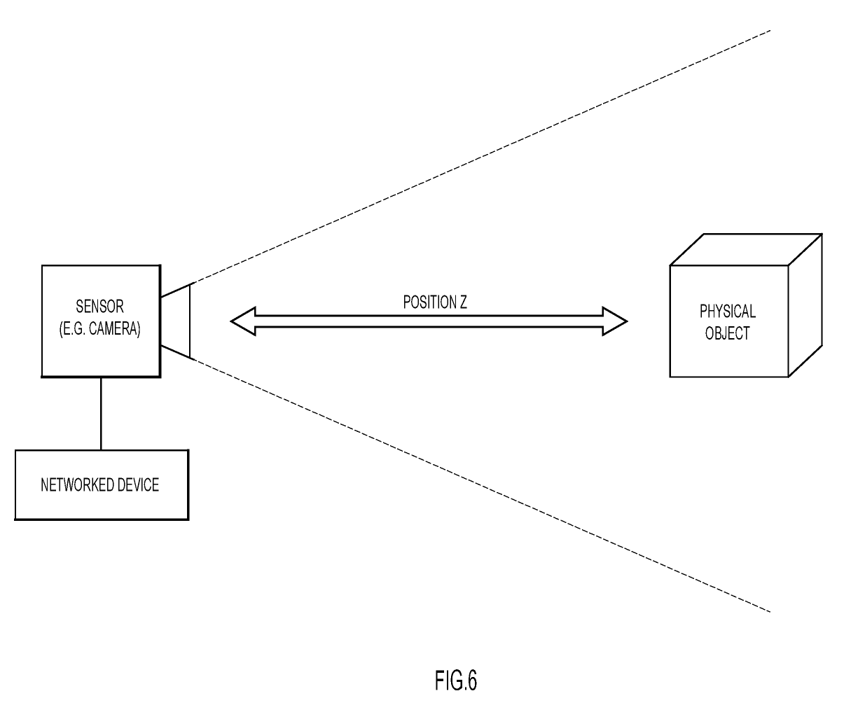

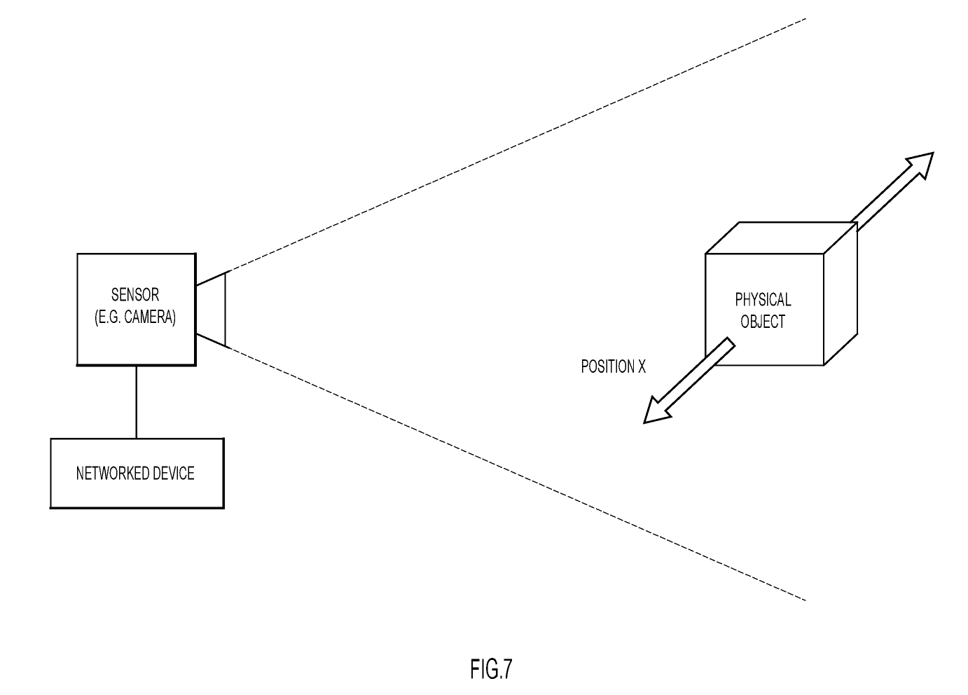

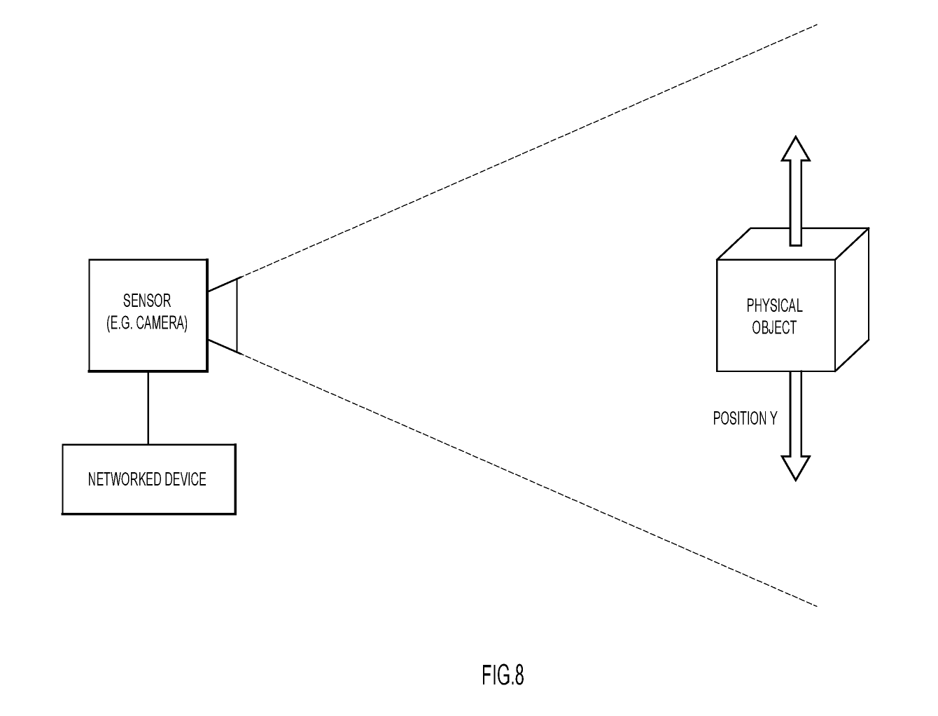

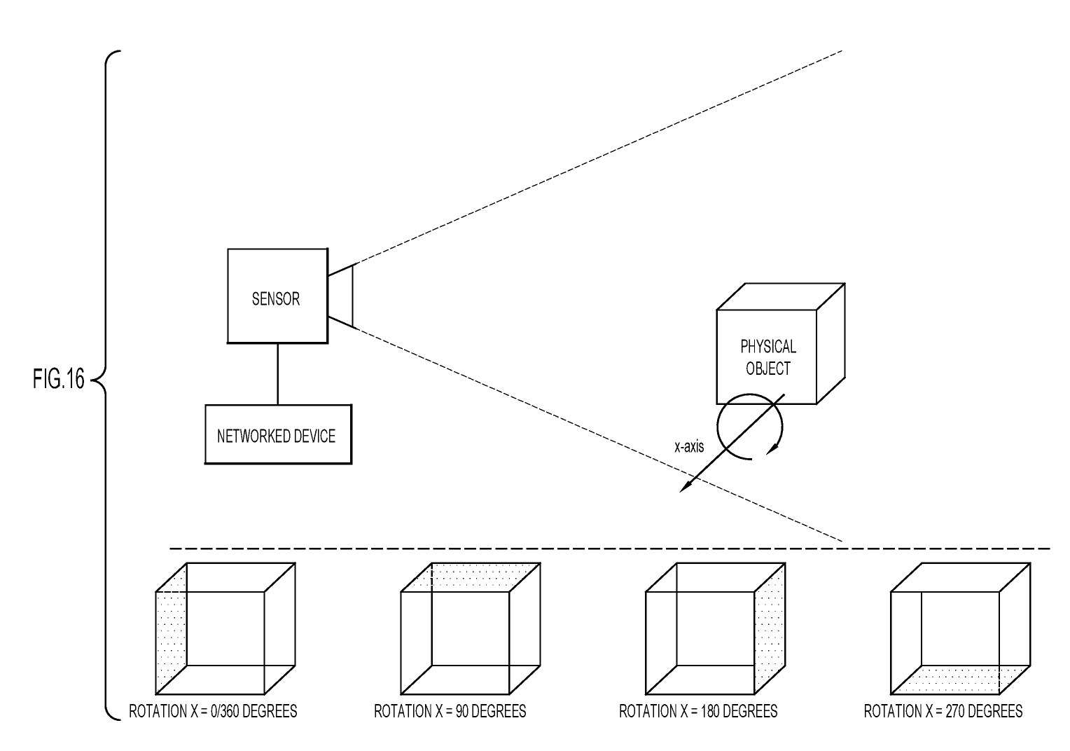

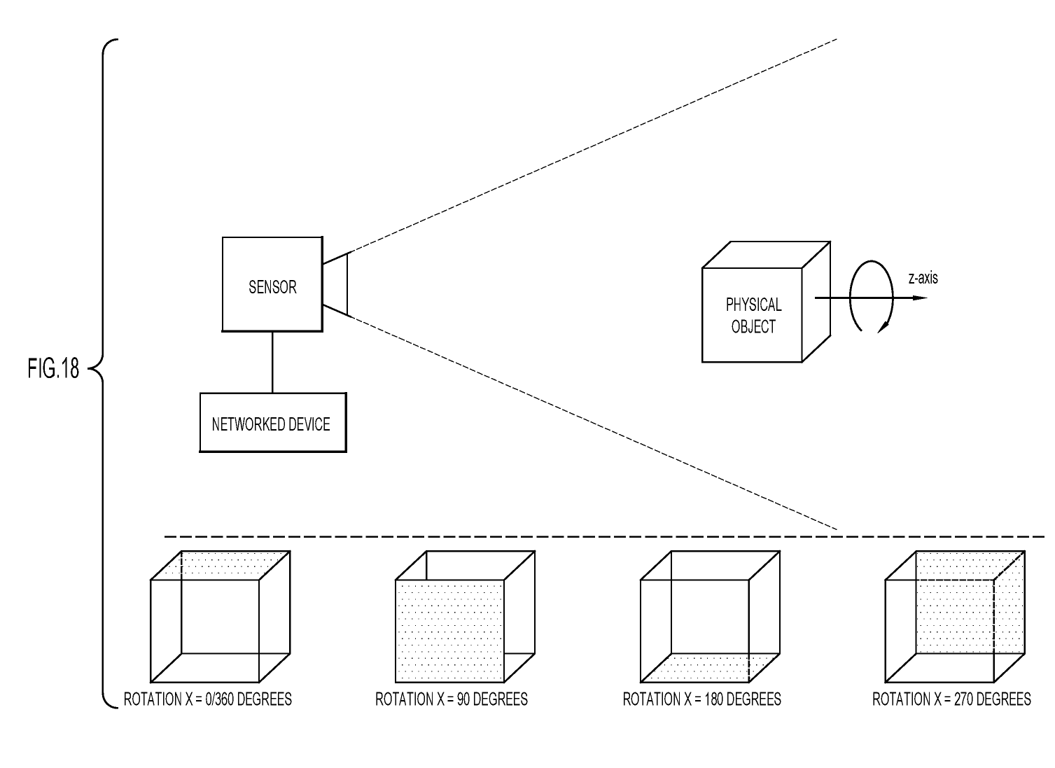

Element 5.7 illustrates an interface for choosing between 6 different dimensional parameters (each parameter represents a respective “signal”) output by the XR Controller. It is understood that that many additional parameters could be sent into the bridge, examples of which were provided above. In terms of the 6 dimensional parameters illustrated as an example here, a user can select between Position X (illustrated in FIG. 7), Position Y (illustrated in FIG. 8), Position Z (illustrated in FIG. 6), Rotation X (illustrated in FIG. 16), Rotation Y (illustrated in FIG. 17), and Rotation Z (illustrated in FIG. 18). In this example, the dimensional parameters are being normalized and converted into a MIDI control message, and panel/section 5.8 shows how, when a dimensional parameter is selected via element 5.7, the selected dimensional parameter can be assigned a specific Controller 5.9 such as “Expression 11” and a specific MIDI channel 5.10 such as Channel “1” or “Global.” The Global channel can also be defined within the bridge. In addition to specifying a MIDI control message, the parameters can be used to control the color and opacity of a light as shown in 5.11. With lighting, when a movement parameter is at its minimum value either the opacity or color could be turned to its lowest value (“start” for color) and when at its maximum value, the color would be brought up to the “end” value or opacity turned up to 100%.

In an alternative or additional embodiment, DMX messages could be assigned, as well as other forms of output control messages. It could also be possible to select multiple output messages for the same input or to control the same output by multiple inputs.

Additionally, other forms of visual feedback can be provided to the user based on input parameters from the XR controllers, controllers and sensors, as well as based on feedback communicated from 3rd Party software, hardware and sensors.

FIG. 6 provides an example illustration of an embodiment in which the system tracks the Z position or depth of the physical object or physical objects in relation to a sensor, such as a camera other motion tracking sensor.

When a camera is used as a sensor (e.g., a webcam attached to a desktop or laptop computer, a camera attached to a mobile device, or any type of camera which is connected to the networked controller that is part of the XR Controller), as the physical object moves closer to the camera, the position Z parameter will increase, and as the physical object moves away from the camera the position Z parameter will decrease. In an example in which the position Z parameter is incorporated into/converted to a MIDI message (MIDI control message) inside the bridge, and the bridge sent the MIDI message to a DAW, and in the DAW an artist tied the relevant MIDI message to a resonance filter, as the user moved the physical object closer to the camera or away from the camera the resonance filter would increase or decrease, respectively. A similar approach may be used to control many different DAW sound controls depending on how the output control message from the bridge is formatted, and the 3rd party software that is used. Similarly, in the case of lighting, the position Z parameter may be incorporated into/converted into a DMX light control message. Thus, as the physical object moves closer to the camera or away from the camera, the corresponding DMX control message generated by the bridge would cause brightness of lights controlled responsive to the DMX control message to increase or dim, respectively. This could be applicable in a home setting, during a live show, amongst a number of other settings.

Alternatively, if a camera is omitted, many other Sensor options are available, as discussed in the “Tracking Physical Objects” section above. If for example Lighthouse tracking technology were used to provide full 3D tracking within a room or other 3D space, position Z could be measured relative how close a person is to the front of a room, with an increase in the parameter as the person moves closer to the front, and how close the person is to the back of the room, with a decrease in the parameter as the person moves closer to the back. Many other options are available, which rely on the assumption that position Z is measured based on a relative or deterministic position of the physical object along the Z-axis in 3D space.

FIG. 7 provides an illustration of how the position of the physical object along the X-axis of the 3D real world space could be tracked. As the physical object moves along the X-axis, the position X parameter adjusts accordingly.

FIG. 8 is similar to FIG. 6 and FIG. 7, but shows movement of the physical object along the Y-axis and how it is translated into a position Y parameter.

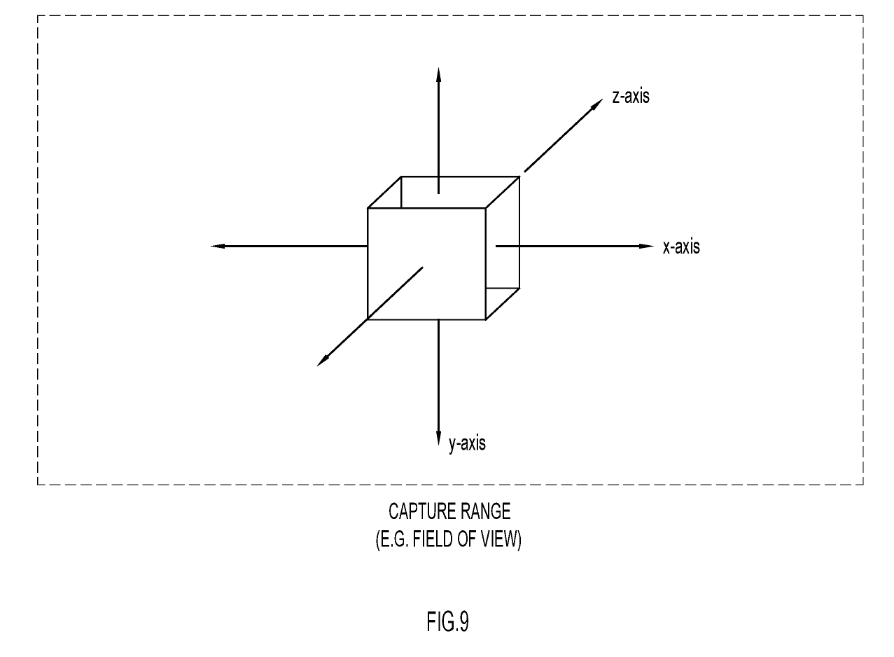

FIG. 9 provides an alternative depiction of how the position of the physical object (or physical objects) can be tracked along the X, Y, and Z axes from the perspective of a camera with a camera field of view. If a camera were not used, the field of view could still be applicable to a scenario where a single, directional sensor is used. An alternative embodiment of tracking of the physical object could include a full 360 degree sensor, or use multiple sensors for detailed full room level motion tracking.

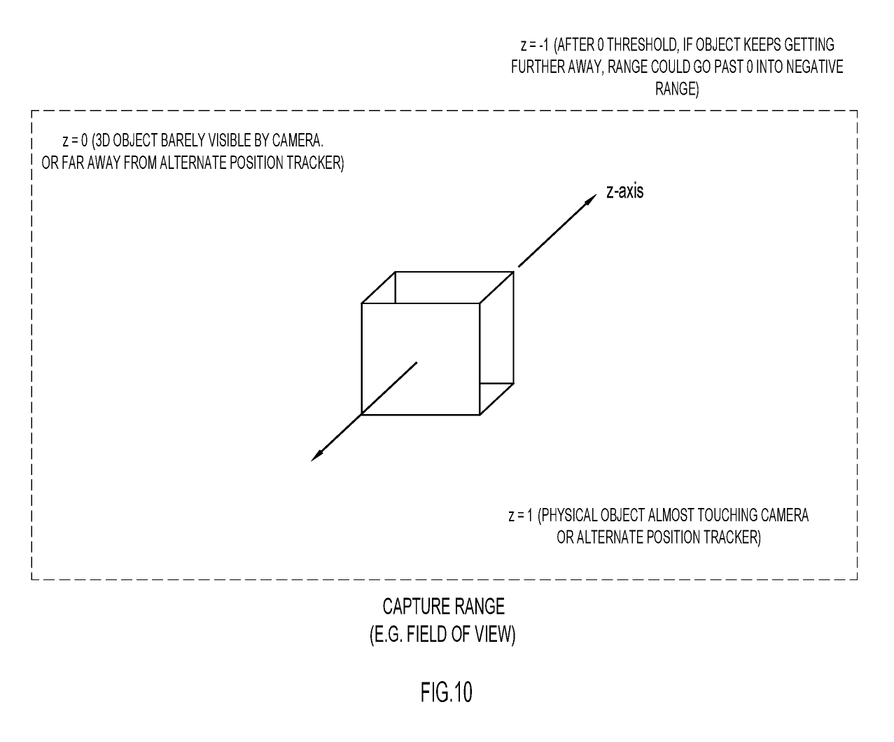

FIG. 10 shows an embodiment of how the physical object can be tracked along the Z-axis within a 2D frame generated by a directional sensor such as a camera. The Z range could change (the range doesn't have to be from 0 to 1), and the values could be relative or absolute, based on the relative or absolute position of the physical object along the Z axis.

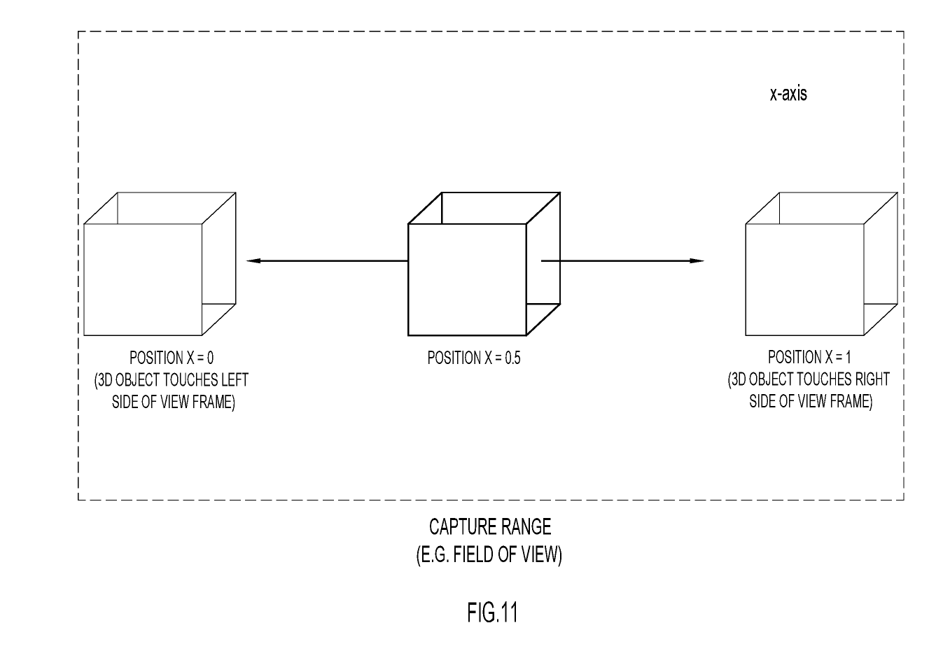

FIG. 11 shows a similar example of tracking the physical object along the X-axis, and how the position X value could shift based on the position of the physical object along the X-axis in a 2D frame. The values for position X could be relative (0 to 1, in one example) or absolute to the physical space. If the position X was absolute, 0 would be the middle position, and positive or negative position X would denote how far away from the middle position the physical object was.

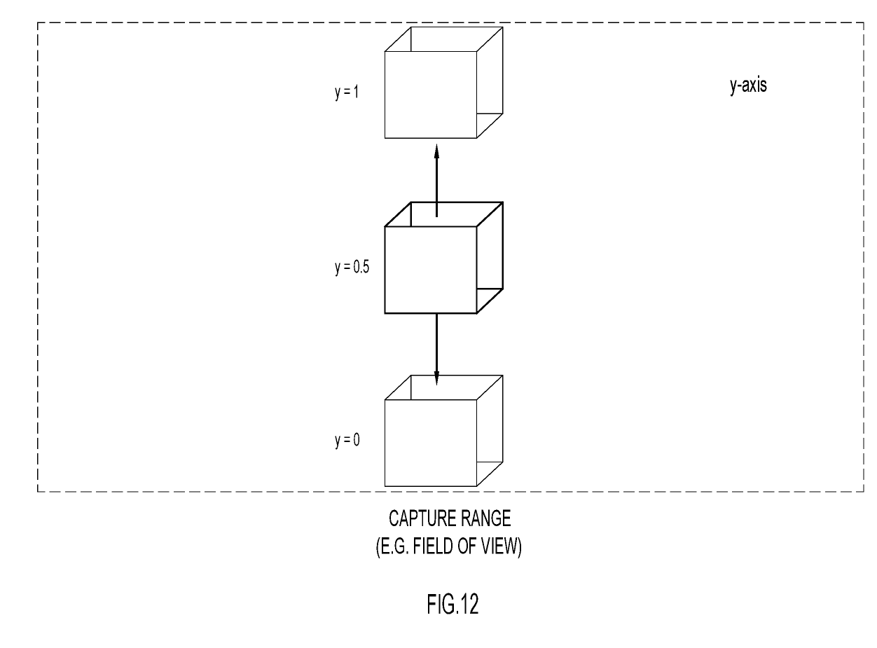

FIG. 12 shows a similar example of tracking the physical object along the Y-axis, which may use relative or absolute ranges. For relative position, the range of position values could be relative from 0 to 1 with 0.5 being the middle of the Field of view, or relative from −1 to 1, with 0 being the middle. Alternatively, for absolute position, the range of position values could be −1 to 1 depending on how absolutely far away the physical object was from the middle position.

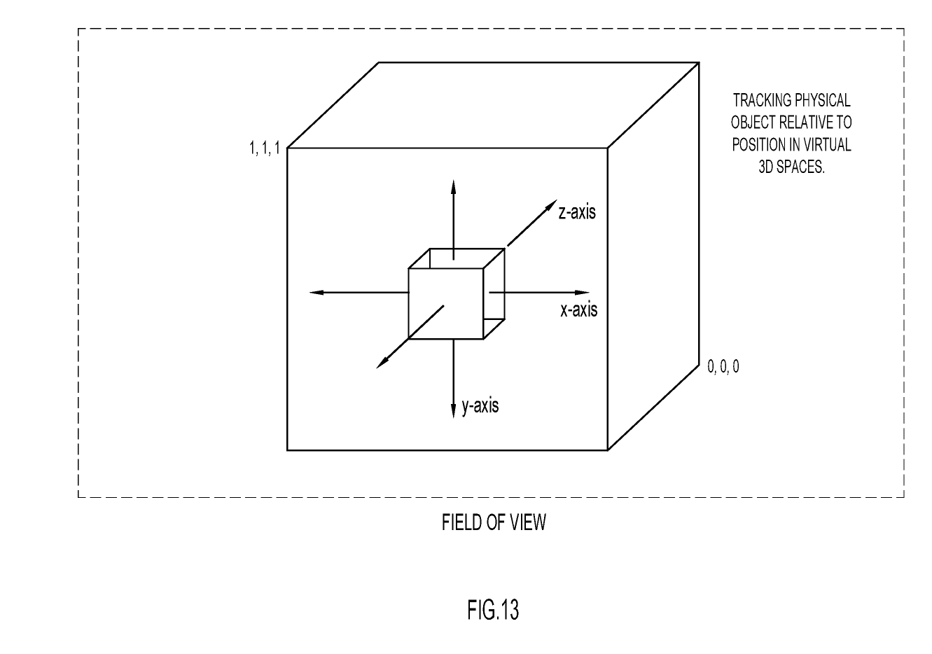

When tracking a physical object relative to the full real world 3D space in which the object is in, or relative to a directional sensor or camera, the positional ranges for the X, Y, and Z axes could be calibrated to determine maximum and minimum values. This may be desirable as the physical object may not always be tracked within an identical 3D space, or with an identical type of sensor, so it may be necessary to determine the size of the space in which the physical object is being tracked. In an embodiment, a calibration is performed at first system startup, or at the user's discretion, by moving the physical object along the X, Y, and Z axes to the maximum and minimum points that the user wants to move the physical object within. Essentially the user constructs a virtual 3D space, as illustrated in FIG. 13. This virtual 3D space could be a cube or a cuboid that is either visible or not visible via the internal or external viewing mechanism of the XR Controller.

FIG. 13 shows additional detail on how the coordinate information of the physical object, and thus X, Y, and Z parameters could be determined relative to either a user constructed virtual 3D space such as a cube or cuboid, or pre-generated 3D spaces that are tied to different “scenes” of a visual representation. If the cube was in the center of the virtual 3D space, parameter X, Y, and Z would each be 0.5 (or whatever value is in the middle of the relative X, Y, and Z ranges). Additionally the size of the virtual 3D space could be determined based on the size of the room or size of the person controlling the physical object.

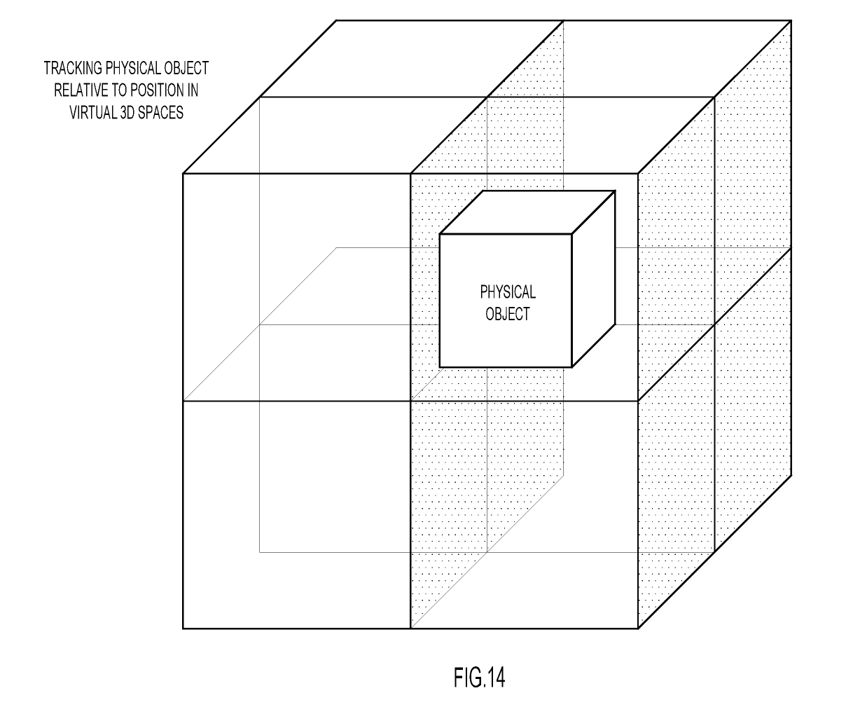

FIG. 14 illustrates an example of multiple virtual 3D spaces. The example includes 8 virtual spaces, but there could many more or as few as one. Each virtual 3D space could have a different set of additional parameters associated with it, which in turn could be passed over to the bridge, or directly to 3rd Party Software and application programming interfaces (APIs). An example use in the music context could be as the physical object moves from one virtual 3D space to another, the underlying music track that is being played could change, or the filters, live clips or instruments the movement of the physical object is tied to could change, or perhaps the visualization of the physical object changes or how the physical object is visible could change.

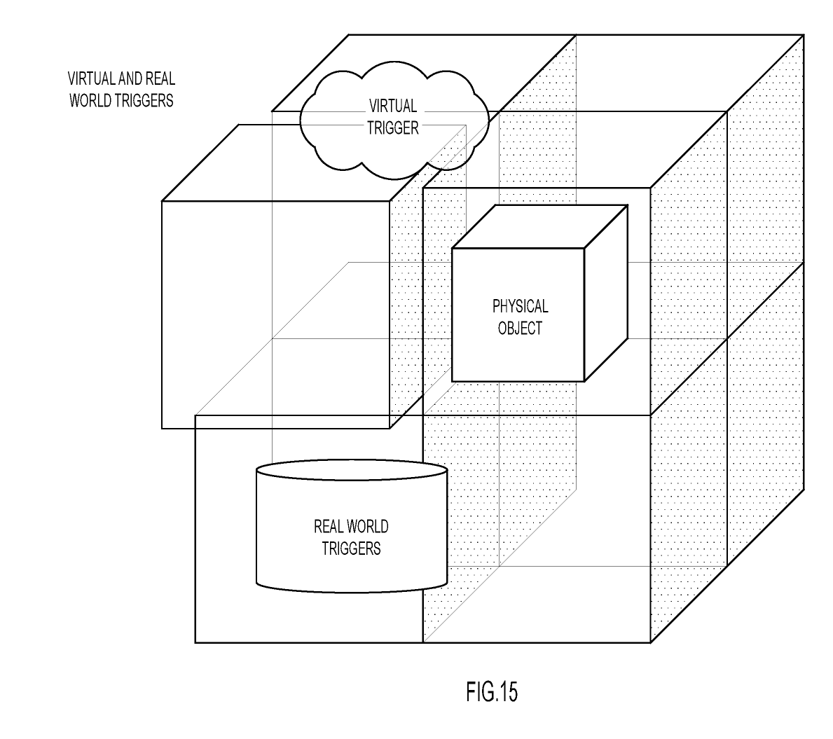

FIG. 15 demonstrates how, in addition to tracking a physical object in virtual or real world 3D spaces to determine relative coordinate information of the physical object as well as other parameter information, Virtual and real world triggers could be placed throughout a scene, and as the physical object makes virtual or real world contact with those triggers, trigger based parameters could be sent out by the XR Controller. In the context of a music example, a virtual trigger could be a representation of a drum or a large chime, and as you hit the trigger and how you hit the trigger will augment the eventual sounds that are produced. Real world triggers could be other objects that exist in the real world, which the XR Controller sensors have detected either via a camera, depth sensor or other means, and as the physical object comes in contact with them or moves near them a trigger event occurs, or behavior of the output parameters of the XR controller temporarily changes. In one embodiment of the innovation, by combining virtual and/or physical world triggers, whole XR-based virtual instruments could be built. Additionally, the triggers can be more than just “on/off” triggers, and could allow for strumming or vibrato like effects (and other effects) based on how the physical object is moved when contacting a trigger.

FIG. 16 demonstrates how rotation along the X-axis of the physical object could be measured relative to a directional sensor such as camera or through any other sensor detection technology. Rotation Y could go from 0 to 360, based on Euclidian geometry.

Alternatively, rotation X could go from 0 to 180 and be calculated based on the relative angle between the Forward Vector relative to the physical object and the Down Vector relative to the real world. So, Down Vector would be the vector always pointing down, and Transform Forward would be the relative vector pointing forward out of the front of the physical object. With this approach, the Euclidean angle range would go from 0 (when the physical object is facing down and thus shares the same vector angle as Vector Down) to 180 when the physical object is facing up. Once the physical object goes past 180 degrees, it would start reducing back to zero. This would mean that there would never be a jump between 0 and 359 degrees.

Alternatively, quaternions (four dimensional vectors) could be used to represent rotation X, which allows to avoid “gimbal lock”.

FIG. 17 demonstrates how rotation along the Y-axis of the physical object could be measured relative to a directional sensor such as camera or through any other sensor detection technology. Rotation Y could go from 0 to 360, based on Euclidian geometry.

Alternatively, Rotation Y could go from 0 to 180 and based on the relative angle between the Forward Vector of the physical object and the real world Vector Left (i.e. the vector produced when rotation Y is at 270 degrees in the figure).

Alternatively, quaternions could be used to represent rotation Y.

FIG. 18 illustrates this for rotation of the physical object along the Z axis.

Alternatively, Rotation Z could go from 0 to 180 and based on the relative angle between the Left Vector of the physical object and the real world vector down.

Alternatively, quaternions could be used to represent rotation Z.

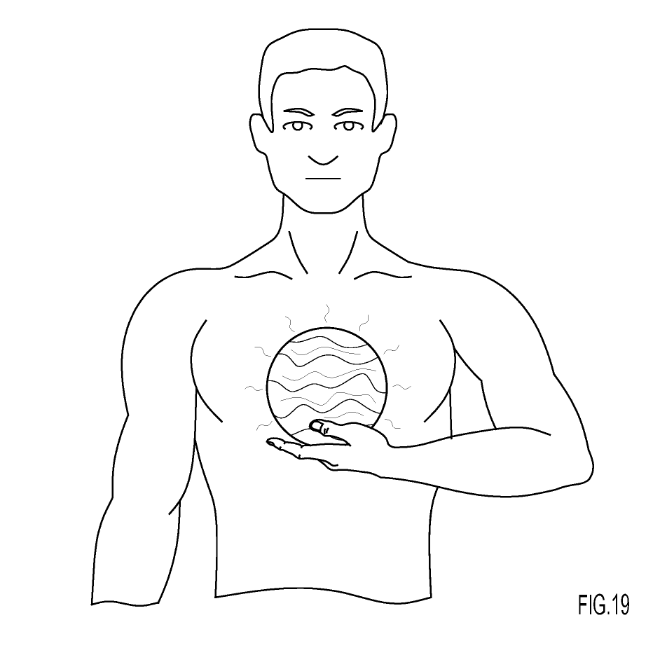

FIG. 19 provides an example of how the physical object can be visualized in a music context. The physical object could be transformed into a glowing, fiery orb and could expand and contract based on the tempo of a song (e.g., as the tempo increases and decreases), the overall size of the orb could increase or decrease based on decibel level or loudness units relative to full scale (LUFs—an audio term for volume level) (e.g., as the loudness increases and decreases), eruptions out of the orb could be based on beat drops, luminescence and color of the orb could be based on the physical objects rotation and position (e.g., rotate left or right transforms color from blue to red, and vice versa, while movement left or right increases and decreases luminescence), and so on.

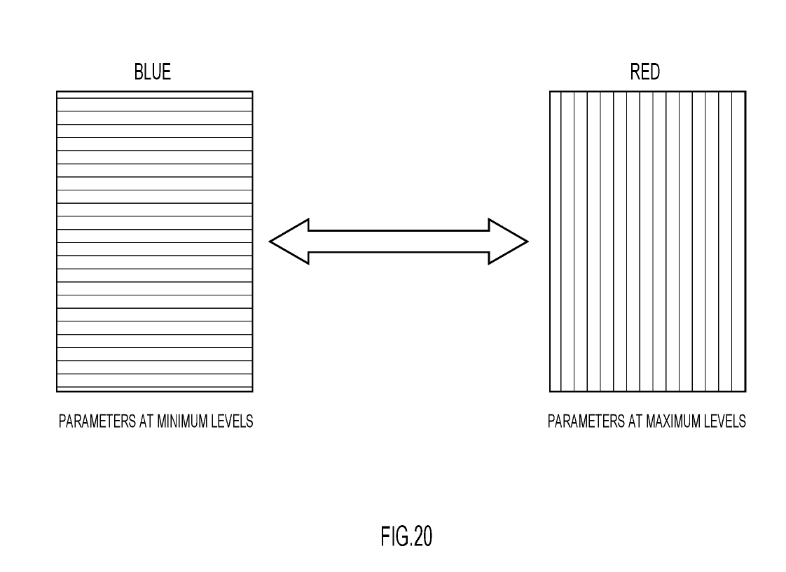

FIG. 20 illustrates a specific color or material transition option that could be based either on direct parameter input from the physical object or from feedback parameters that come from the bridge or from 3rd Party Software.

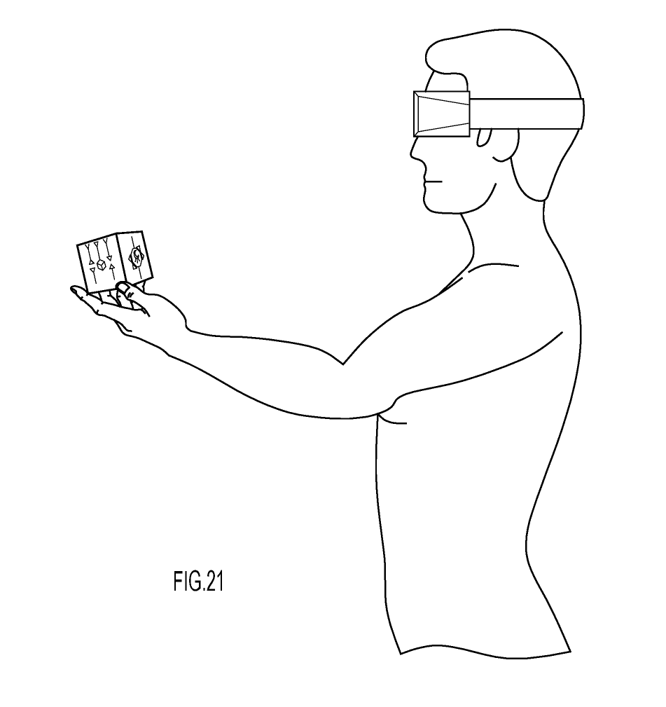

FIG. 21 shows an example of the XR Controller leveraging an XR viewing headset which could be a mobile phone placed close to the eyes as is already possible with 3^{rd} party headsets provided by manufacturers such as MergeVR, Google Cardboard, and so on. In this instance the networked controller, internal viewing mechanism, and camera (all part of a mobile phone), are worn inside a headset close to the eyes, so that an immersive extended reality experience can be attained. Alternatively, the headset does not have to rely on an external computing device such as a mobile phone, and can be a complete unit such as those provided by Magic Leap, Microsoft with the HoloLens, Meta Vision, and so on.

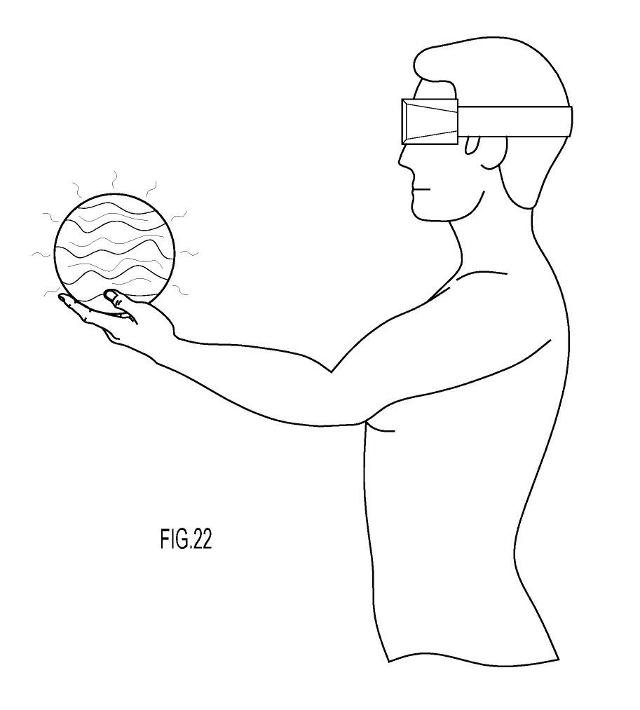

FIG. 22 shows an example of how the physical object is transformed into a glowing orb when viewed by the User utilizing the internal viewing mechanism of the XR Controller.

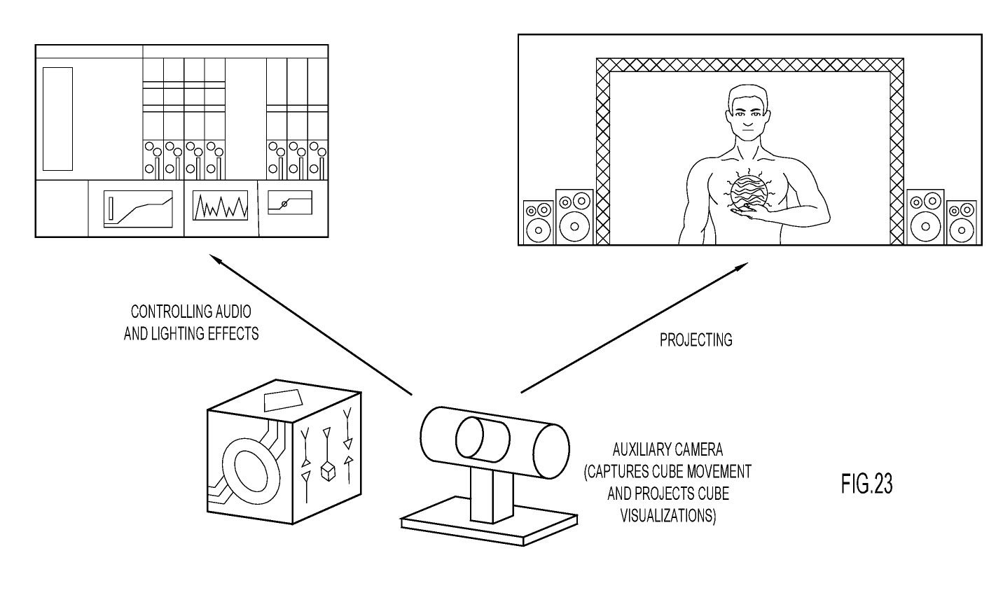

FIG. 23 shows an alternative embodiment, where no headset is being worn (so the XR experience is less immersive), but instead a webcam or auxiliary camera connected to a laptop is used as the XR Controller, and the user can view himself or herself and the physical object on the monitor connected to their laptop, and have a similar visual projected to a Jumbotron for the audience to view.

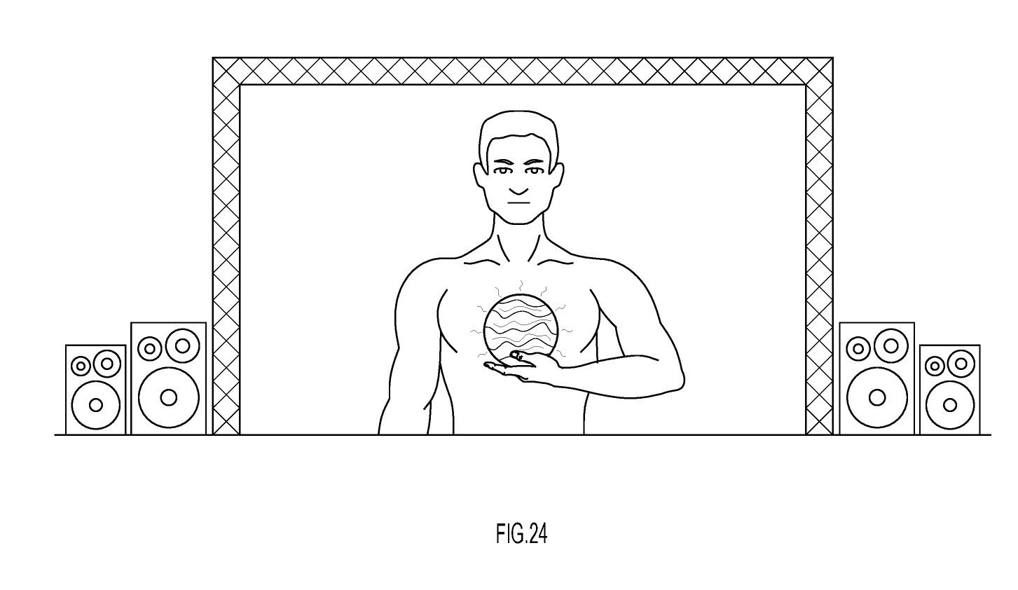

FIG. 24 shows an example embodiment of an external XR or non-XR viewing mechanism, in this case a Jumbotron placed on a stage displaying the actions of the user to a large audience. Additionally, that user could be simultaneously controlling which audio and lighting affects the physical objects are tied to within 3rd Party Software such as a DAW.

FIG. 26 is described above and illustrates how a person could be tracked against the unique pattern background based on which part of the background the human is covering. Any other form of physical object could be tracked in this way as well.

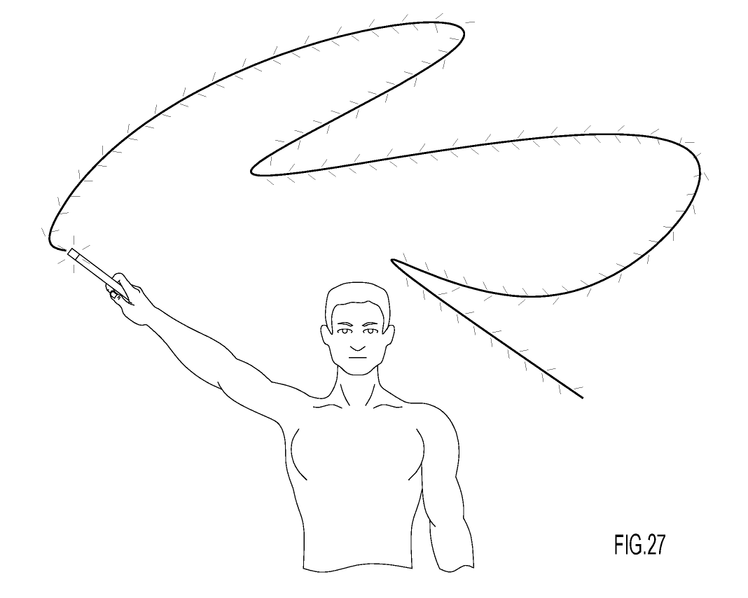

FIG. 27 illustrates another example XR visualization that could be manipulated by both the physical objects movements and by feedback parameters. In this case, a trail of light particles could be left behind as the physical object moves through space, like the trail of light left by a sparkler. The light particles could also vibrate and react based on feedback parameters coming from the bridge or 3rd Party Software.

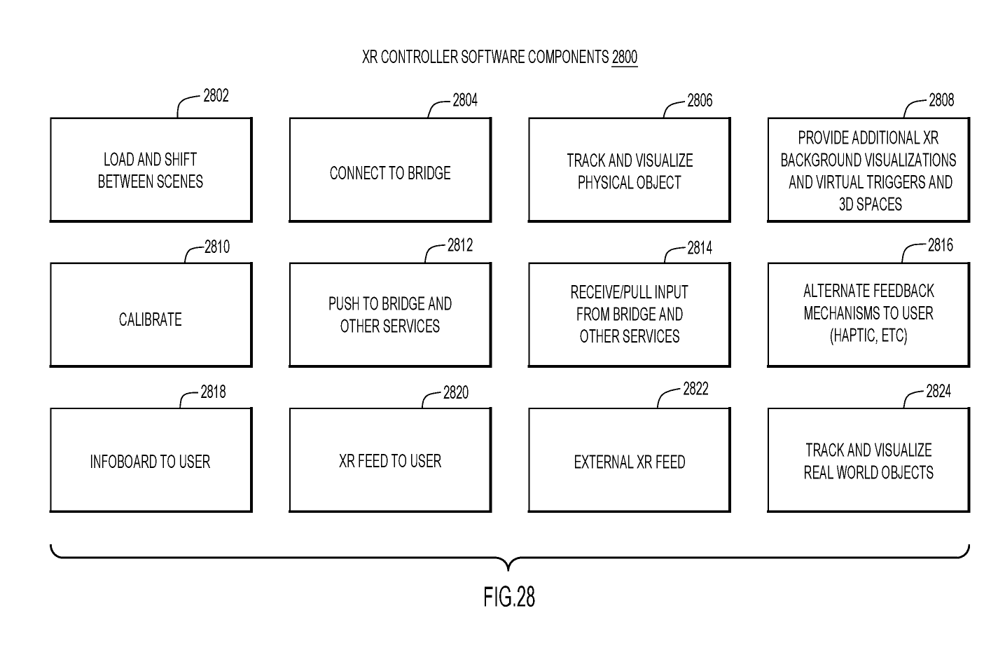

FIG. 28 shows example logic, e.g., software components 2800 included in the software component of the XR Controller. Components 2800 include the following modules: 2802 for load and shift between scenes; 2804 for connect to bridge; 2806 for track and visualize object; 2808 for provide additional XR background visualizations and virtual triggers and 3D spaces; 2810 for calibrate; 2812 for push to bridge and other services; 2814 for receive/pull input from bridge and other services; 2816 for alternate feedback mechanisms to user; 2818 for infoboard to user; 2820 for XR feed to user; 2822 for external XR feed; and 2824 for track and visualize real world objects.

The software component of the XR Controller can utilize 3^{rd} party software, 3^{rd} party software development kits (SDKs), and 3^{rd} party software libraries. For example, Unity is a commonly used piece of software used to create AR applications that can run on networked devices such as a mobile phone. Within Unity, a 3^{rd} party SDK such as Vuforia could be used to make it easier to program the tracking of real world objects. Alongside a number of other 3^{rd} party software libraries to facilitate thing such as networking protocols to communicate to the bridge, a complete software component can be completed and then bundled into a medium that can be easily installable onto a networked device 1.3. The software component could be distributed directly or utilizing, but not limited to, App listing stores such as the Google Play Store, iTunes App store and Oculus App store.

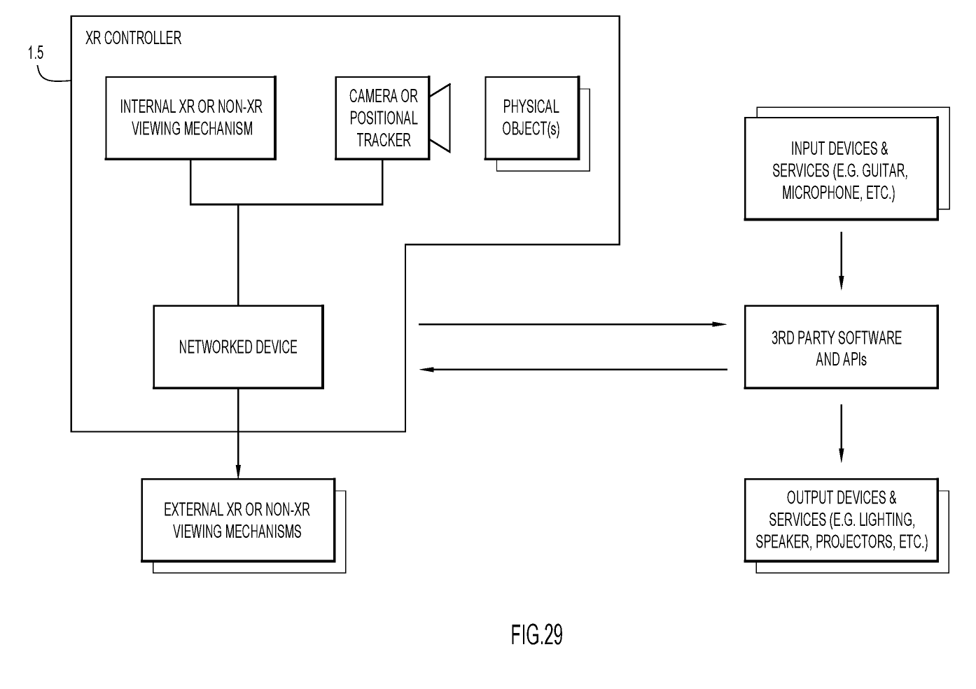

FIG. 29 is an example system architecture for an XR controller and visualizer in which the XR Controller communicates directly with 3rd Party Software or APIs, without a bridge.

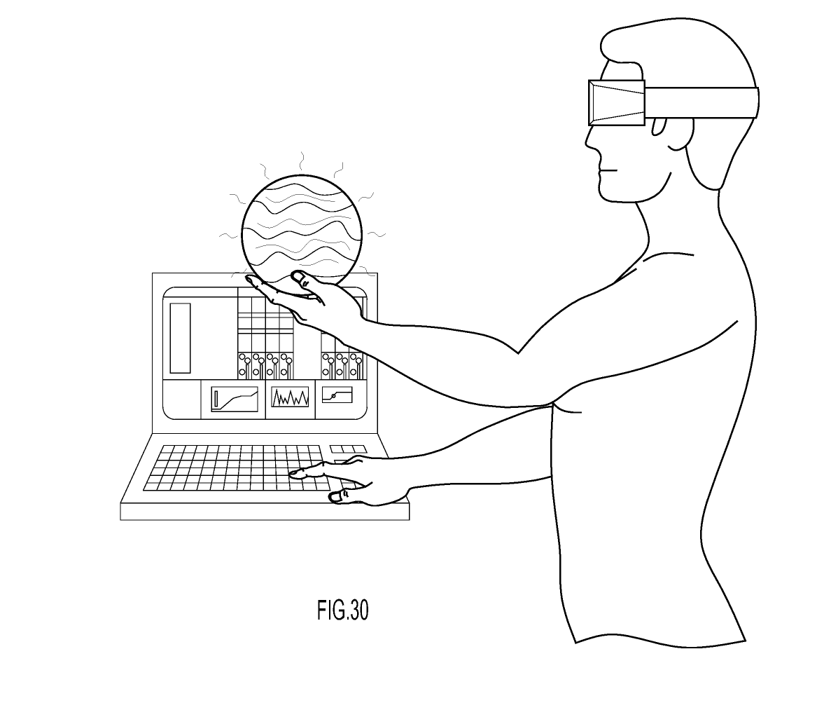

FIG. 30 is an illustration of an example in which a user is wearing an XR headset and when viewing the physical object it is transformed into a glowing sun. Additionally, the user is in front of a DAW, e.g., Ableton Live, and is playing musical notes on a laptop keyboard, and is manipulating the notes in real time based on the rotation and movement of the physical object. In this instance the user has already mapped rotational and positional parameters to different MIDI controller messages utilizing the bridge, and mapped those parameters in Ableton Live to different synthesizer effects thus representative of the rotational and positional parameters.

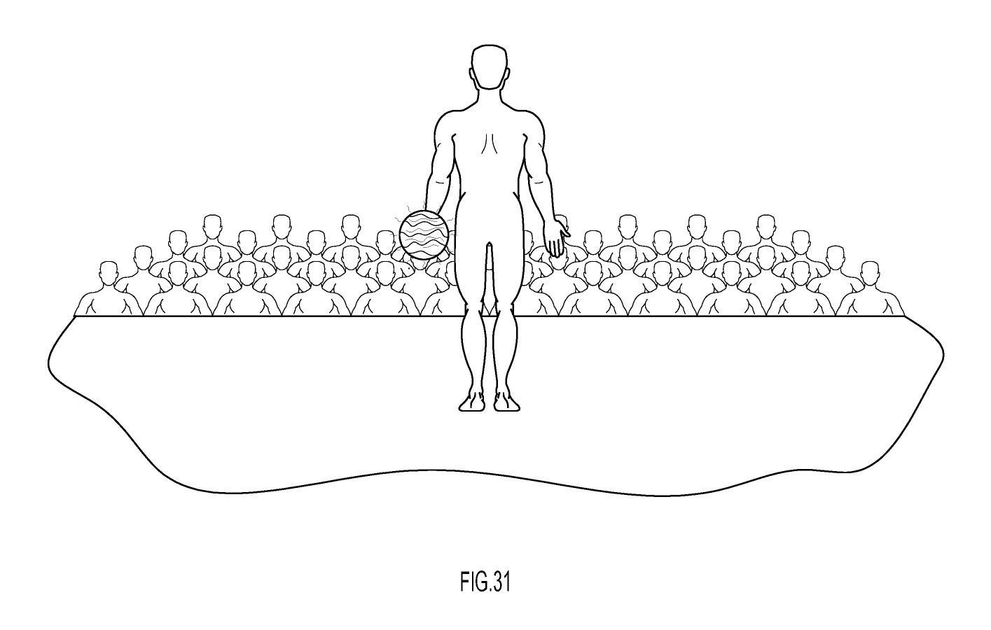

FIG. 31 is an illustration of an example of how the invention could be used in a live performance setting. In this instance, a producer is holding the physical object in his or her hand. To the audience though, if they are viewing the producer via an XR viewing mechanism, the physical object appears as a glowing sun. Then, as the producer performs, he or she could move and interact with the physical object, freely expressing himself or herself creatively, in a sense dancing and moving to the music as he or she manipulates the music along multiple musical parameters. He or she is freed from the laptop keyboard as well as the traditional control boards with knobs and pads.

FIG. 32 provides an example illustration of how visualizations could be displayed above an audience. In this instance, the glowing sun that was in the producer's hand and directly tied to the physical object in FIG. 31, is now levitating above the audience and its movements are directly manipulated by the producer in real time relative to the movements of the physical object in the producer's hand or based on the input of a sensor or controller 2.8 such as a sensored glove.

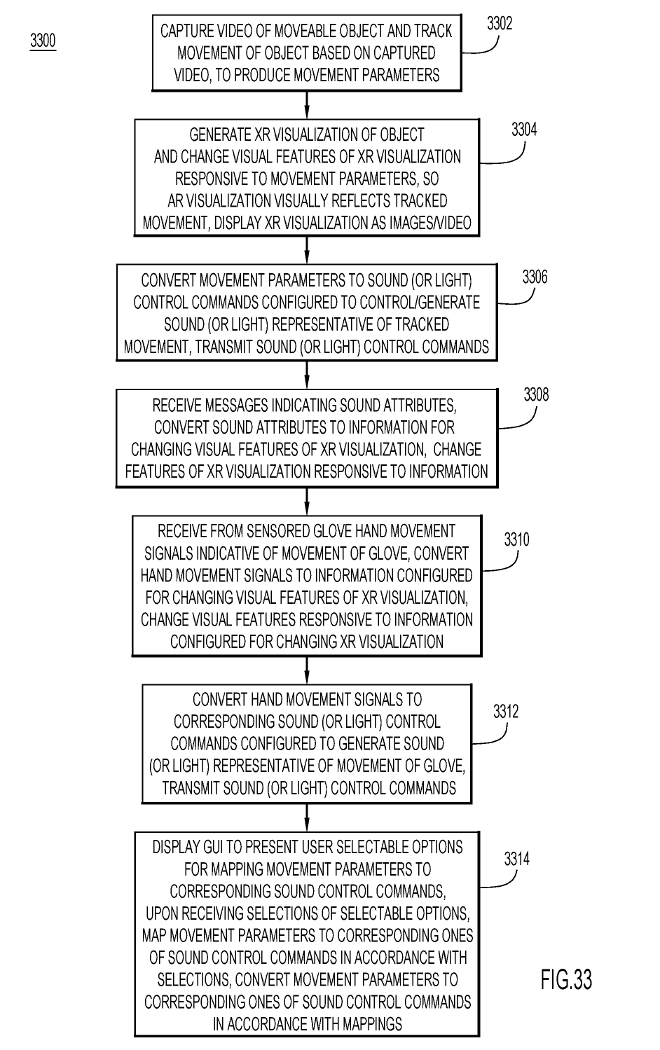

Referring to FIG. 33, there is a flowchart of an example method 3300 of implementing XR visualization in the systems described above, e.g., in the system of FIG. 1.

At 3302, a video camera of XR controller 1.5 captures video/images of 3D moveable object 1.1 in a scene, and the XR controller tracks movement of the object in in the scene (e.g., including 3D position and multi-dimensional rotation of the object, such as X, Y, and Z position and rotation about X, Y, and Z axes) based on the captured video/images, to produce multiple movement parameters or “movement signals” (e.g., 3D position and rotation parameters or movement signals) that define the movement in 3D space. The object may have unique indicia inscribed on various sides of the object to enable camera tracking of the object. Tracking of the movement includes image processing of the video/images to derive the object movement information.

At 3304, the XR controller generates an XR visualization of the physical object in the scene and changes visual features of the XR visualization responsive to corresponding changes in at least some of the multiple movement parameters, such that the visual features of the XR visualization visually reflect/represent the tracked movement. The XR controller displays the XR visualization and changes thereto on a display of the XR controller. The XR visualization may include an animated object (e.g., a fiery orb) that overlays a tracked position of the object in the scene. The visual features may include 3D position, multi-dimensional rotation, brightness, color, shading, size (e.g., diameter), and rotation of the animated object as displayed. The brightness, color, shading, size, and rotation of the animated object may each change between different values/characteristics thereof responsive to a change in a corresponding one of the movement parameters, for example. Changes to the XR visualization may include addition of further XR visualization on top of or beside the original XR visualization. Also, 3D positional movement of the physical object may not change a corresponding 3D position of the physical object or overlay in the XR visualization/scene as displayed, but rather may change a non-3D positional visual feature such as size (from a smaller size to a larger size or vice versa), color (e.g., from blue to green or vice versa), or shape (e.g., from an orb to a star). That is, movement of the physical object may result a change between values/characteristics of a non-movement visual feature. In an embodiment, the XR visualization may include a light field or a hologram.

At optional operation 3306, the XR controller sends the multiple movement parameters to a bridge, which receives the movement parameters. The bridge converts the movement parameters to corresponding ones of different sound control messages, e.g., different types of MIDI or OSC messages, and transmits the sound control messages to an external entity, such as a DAW configured to control sound responsive to the sound control messages.

Additionally, at 3306, the bridge may also convert the movement parameters to corresponding ones of different light control messages, e.g., DMX messages, configured to generate/control light representative of the movement. The bridge transmits the light control messages to an external entity, such as a DMX light controller configured to control light/illumination responsive to the light control messages.

Additionally, at 3306, the bridge may also convert the movement parameters to other control messages such as OSC message or JSON messages, which can be sent to other 3rd party software.

At optional operation 3308, the bridge receives from an external entity, e.g., a DAW, messages representative of sound attributes of sound generated by the external entity, e.g. in PCM format, or in the form of MIDI and/or OSC messages, converts the sound attributes to visually renderable information, e.g. in the form of floating point value vectors created by a Fast Fourier Transform (FFT) applied to the frequency spectrum, and transmits the visually renderable information (i.e., information configured for XR visualization or changes thereto) to the XR controller. The XR controller receives the visually renderable information and changes the visual features of the XR visualization responsive to the visually renderable information. The information configured for XR visualization or changes thereto represents, and thus is also referred to as, control messages configured for controlling/changing the XR visualization.

At optional operation 3310:
a. The bridge receives, from sensors of a sensored glove for a human hand, hand movement signals indicative of movement of the glove (generally) and of fingers of the glove in 3-dimensional (3D) space.
b. The bridge converts the hand movement signals to information (e.g., visually renderable information that represents hand gestures) configured for changing the XR visualization (i.e., also referred to as “control messages configured to change visual features the XR visualization”), and transmits the information to the XR controller; and
c. The XR controller receives from bridge the information configured for changing the XR visualization, and changes the visual features of the XR visualization responsive to the information.

At optional operation 3312:
a. The bridge converts the hand movement signals to sound and/or light control messages representative of the movement of the glove, and transmits the sound and/or light control messages to a DAW and/or a light controller to control sound and/or light, respectively.

At optional operation 3314:
a. The bridge presents on a display of the bridge a GUI to present user selectable options for controlling operation of the bridge. For example, the GUI may present user selectable options for mapping the movement parameters to corresponding ones of the different sound control messages.
b. Upon receiving selections of the selectable options from a user via the GUI, the bridge maps the movement parameters to the corresponding ones of the different sound control messages in accordance with the selections.
c. Then, the bridge converts movement parameters received from the XR controller to the corresponding ones of the different sound control messages in accordance with the mappings, and transmits the sound control messages.

In addition, the bridge may receive movement signals indicative of movement of a second physical object from a second XR controller, covert the movements signals to control messages configured to control one or more of the XR visualization for the physical object mention above, sound, or light, and transmit the control messages to one or more of the XR controller, the sound controller, or the light controller.

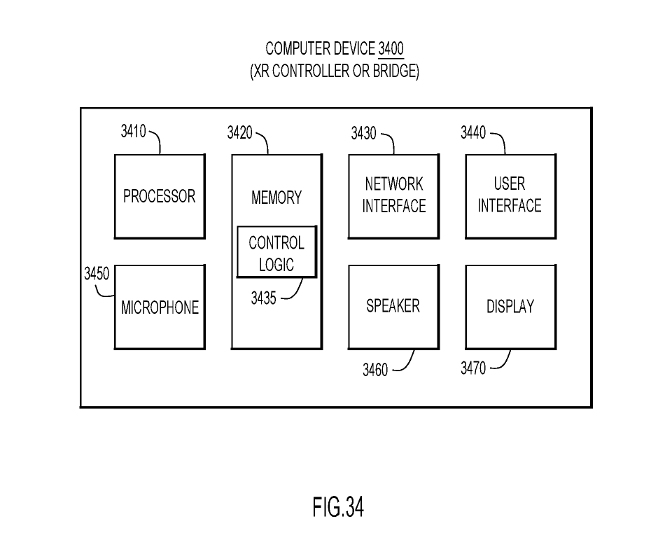

FIG. 34 is a block diagram of an example computer device 3400 representative of any one of the XR controller and the bridge, except that the computer device does not include the physical object. The computer device 3400 includes a processor or controller 3410 to process instructions relevant to communication sessions, memory 3420 to store a variety of data and software instructions. The processor 3410 is, for example, a microprocessor or microcontroller that executes instructions of computer device control logic 3435 in memory 3420 for implementing the processes described herein for the XR controller or the bridge. The computer device also includes a network interface unit (e.g., card) 3430 to communicate with other devices over a communication network, such as the Internet and/or a local area network (LAN). Network interface unit 3430 may include an Ethernet card with a port (or multiple such devices) to communicate over wired Ethernet links and/or a wireless communication card with a wireless transceiver to communicate over wireless links. The computer device 3400 also includes other interface units, including hardware plugs and/or receptacles to connect physically to other devices, optical interfaces, audio interfaces, and the like.

The computer device may further include a user interface unit 3440 to receive input from a user, microphone 3450 and loudspeaker 3460. The user interface unit 3440 may be in the form of a keyboard, mouse and/or a touchscreen user interface to allow for a user to interface with the computer device. Microphone 3450 and loudspeaker 3460 enable audio to be recorded and output. The computer device may also comprise a display 3470, including, e.g., a touchscreen display, that can display data to a user.

Memory 3420 may comprise read only memory (ROM), random access memory (RAM), magnetic disk storage media devices, optical storage media devices, flash memory devices, electrical, optical, or other physical/tangible (e.g., non-transitory) memory storage devices. Thus, in general, the memory 3420 may comprise one or more tangible (non-transitory) computer readable storage media (e.g., a memory device) encoded with software (e.g., control logic/software 3435) comprising computer executable instructions and when the software is executed (by the processor 3410) it is operable to perform the operations described herein directed to the XR controller or the bridge. Logic 3435 includes instructions to generate and display graphical user interfaces to present information on display 3470 and allow a user to provide input to the computer device 3400 through, e.g., user selectable options of the graphical user interface. Memory 3420 also stores data generated and used by computer device control logic 3435.

FIG. 35 presents a flow diagram for an embodiment where an artist is wearing sensored gloves and is also using an XR controller to layer a hologram on top of a physical object and project the AR visual to an audience.

3500 represents sensored gloves and glove software that can be executing on a networked device connected to the gloves and configured to transmit control messages that the bridge receives. The gloves and glove software could be provided by a 3rd party. The messages may be in the form of MIDI control messages, OSC control messages, or another form. The bridge receives the control messages, and then normalizes the values that are received in the control messages to a numerical range, for example −1 to 1 or 0 to 1, or to distinctive trigger events that can be represented by “on” or “off” values such as two numerical states of 1 representing the trigger event, and 0 representing the non-trigger state.

3502 represents how the normalized values can be mapped in the bridge to a MIDI control message that is then sent to a Digital Audio Workstation (DAW) such as Ableton Live.

3504 represents how the normalized values can additionally be assigned to specific holographic effects that run within the XR Controller. The software executing on the XR Controller includes different holographic visualizations and holographic visual effects that have been programmed to be layered on top of physical objects tracked by the XR Controller. Upon receiving normalized values from the bridge, specific effects can either be triggered, based on the trigger events sent by the bridge, as well as progressively adjusted based on a range of values.

3506 represents how the bridge can receive a response back from the DAW, such as a MIDI control messages that represents beats per minute of the audio, or the direct audio feed that is output by the Digital Audio Workstation.

3508 represents how an output device such as a speaker can be connected to the Digital Audio Workstation, to output the audio to an audience.

3510 represents how a viewing mechanism can be connected to the XR Controller, to display holographic visualizations to the audience. For example, the viewing mechanism could be a Jumbotron. Alternatively, audience members could each have an XR viewing mechanism themselves so that they don't need to view the XR visual on a Jumbotron for example, but instead could view the XR visual via a device, such as a set of XR Goggles that they each wear.

3512 represents how the same XR Controller discussed above can receive input control messages from the bridge. If the bridge receives a raw audio stream, the bridge can process the raw audio stream, including performing a frequency analysis on the audio stream, to determine properties of the music such as decibel level, beat drops, and tonal quality, and then (i) normalize and deliver those properties to the XR Controller, and (2) use the normalized properties to either trigger specific effects or to progressively manipulate an effect over time based on a range of numerical values that will be send multiple times per second based on the auditory properties at each timestamp. 3516 represents the viewing mechanism that was discussed in 3510.

3514 represents how the XR Controller can use a microphone to detect the audio stream being output by a set of speakers, and then within the software executing on the XR Controller, execute an audio frequency analyzer to convert the stream in to specific range based and trigger bases numerical properties that can be used to control visualizations layered onto of the physical objects that the XR Controller is tracking.

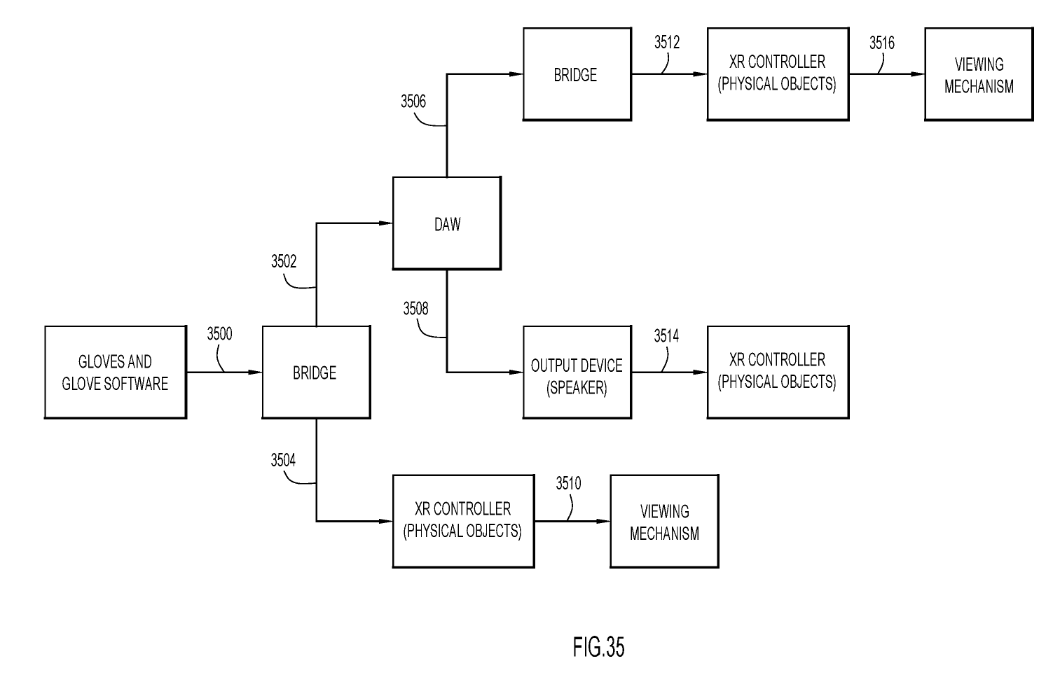

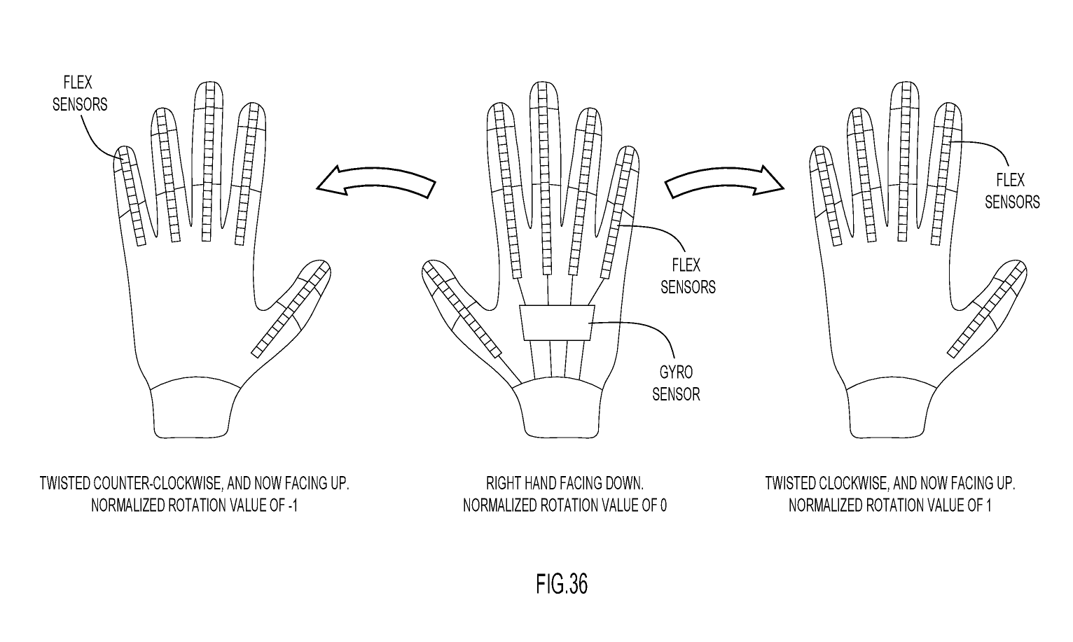

FIG. 36 demonstrates how when wearing a sensored glove, rotation of the hand and arm could be detected, as it moves from palm facing down (middle glove in figure, view of back of hand) and rotated clockwise (right glove in figure, view of palm) or rotated counter-clockwise (left glove in figure, view of palm).

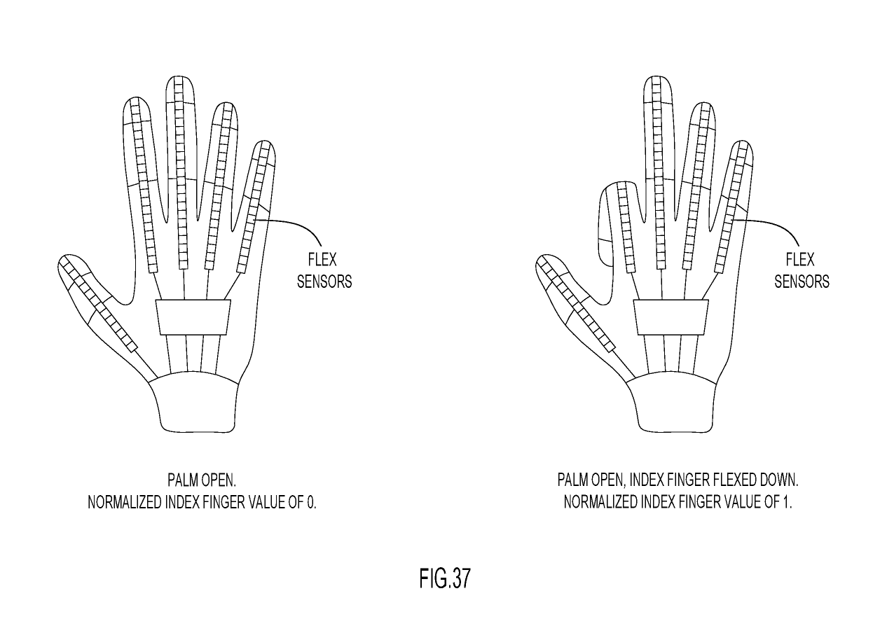

FIG. 37 demonstrates how when wearing a sensored glove (left glove in figure, view of back of hand), the movement of a finger (right glove in figure) could be detected, and the range of motion normalized to values between 0 and 1.

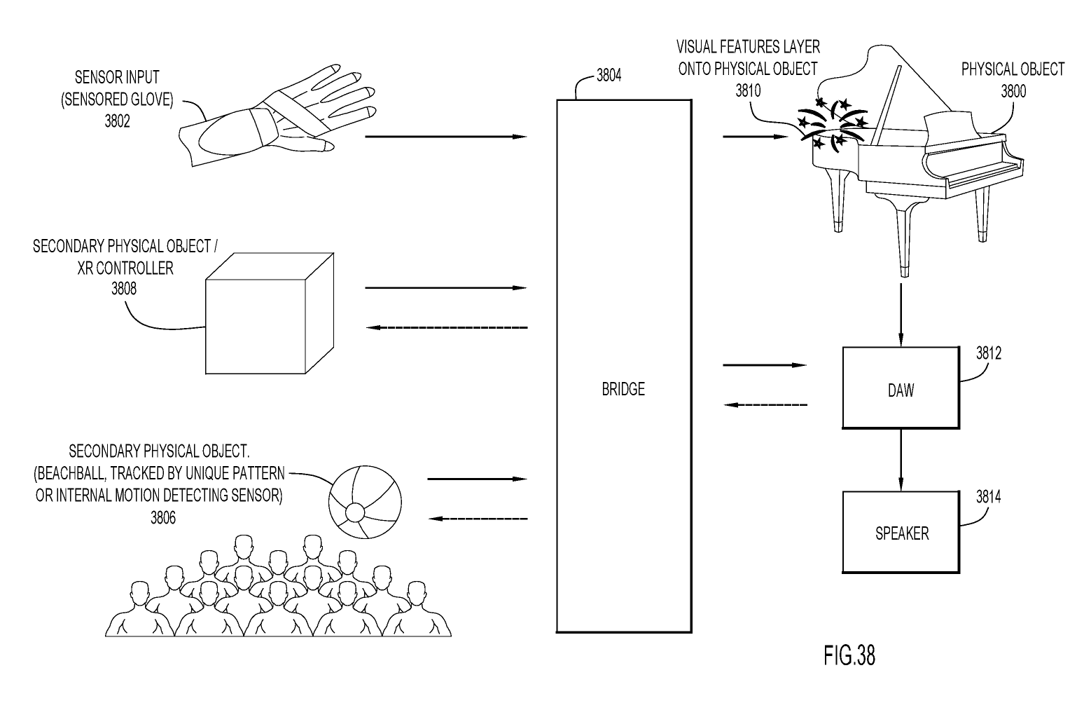

FIG. 38 is an illustration of an embodiment in which XR visualizations are layered on top of a (static) physical object 3800, e.g., a grand piano. A unique pattern can be placed on the piano that the XR controller can track or the unique shape of the piano itself can be used for tracking by the XR controller. As a user performs on the piano, the output can be sent to a DAW 3812. Output of the DAW may be sent to a speaker, 3814. Additionally, an output of the DAW can be sent to bridge 3804. Bridge 3804 processes and normalizes the output from DAW 3812 to produce XR visualization control messages, and sends the messages to the XR controller, which controls the XR visualizations layered on top of the piano images responsive to the messages. The XR visualizations on the piano can be viewed through an XR viewer, such as mobile phones or XR headsets in the audience, or via a camera on stage that captures the piano, layers the visualization on top of the piano, and projects it to a Jumbotron. XR visuals can also being mixed throughout the audience such as the glowing sun hovering above the audience as shown in FIG. 32 that is also reaction to the music and reaction to control messages sent out by the bridge.

Components 3802, 3808, and 3806 represent different types of controllers that can provided movement signals to bridge 3804, which normalizes the signals, and outputs resulting sound control messages to the DAW, outputs resulting light control messages to a light controller, or outputs resulting XR visualization control messages to be provided to the XR controller or other XR visualization applications running on XR viewing devices (whether camera on stage, or XR devices in an audience such as mobile phones) set up to view the XR visualizations. 3802 represents a sensored glove. 3808 represents a separate/second XR controller that tracks a second physical object (e.g., cube). 3806 represents a beach ball-like object that is passed around the audience. The ball-like object includes internal sensors that track movement of the ball-like object, and transmit movement signals indicative of the Alternatively, the ball-like object is covered with a unique pattern that is tracked by a camera. When viewed by audience members and their XR viewing devices, it may be possible to also see an XR visual layered on top of the ball-like object that are reactive to the music and to multiple control messages received by bridge 3804, similar to how the visuals on top of the piano react to the music and to multiple control messages.

In summary, in one aspect, a method is provided comprising: capturing images of a movable object in a scene and tracking movement of the object in the scene based on the images, to produce movement parameters that define the movement; generating for display an extended reality (XR) visualization of the physical object in the scene and changing the XR visualization responsive to changing ones of the movement parameters, such that the XR visualization visually reflects the tracked movement; displaying the XR visualization; and converting the movement parameters to control messages configured to control one or more of sound and light, and transmitting the control messages.

In another aspect, a system is provided comprising: an extended reality (XR) controller including: a camera to capture images of a movable object in a scene; a controller coupled to the video camera and configured to: track movement of the object in the scene based on the images; and generate for display an extended reality (XR) visualization of the physical object in the scene and changes to the XR visualization responsive to the tracked movement; and a display coupled to the camera and the controller and configured to display the XR visualization; and a bridge coupled to the controller and configured to: convert the tracked movement to control messages configured to control one or more of sound and light; and transmit the control messages.

In yet another aspect, a system is provided comprising: an extended reality (XR) controller including: a camera to capture images of a primary physical object; a controller coupled to the video camera and configured to: track a position of the primary physical object based on the images; and generate for display an extended reality (XR) visualization for the primary physical object responsive to the tracked position; and a display coupled to the camera and the controller and configured to display the XR visualization; and a bridge coupled to the XR controller and configured to: receive from a secondary physical object movement signals indicative of movement of the secondary physical object; and convert the movement signals to control messages configured to control one or more of sound, light, and the XR visualization; and transmit the control messages to control the one or more of the sound, the light, and the XR visuals.

In yet another aspect, a non-transitory computer readable medium encoded with instructions is provided. The instructions, when executed by a processor/controller (e.g., of an XR controller or a bridge), cause the processor/controller to perform operations of the methods described herein for the XR controller and the bridge.

In yet another aspect, a non-transitory computer readable medium encoded with instructions is provided. The instructions, when executed by a controller, cause the controller to perform: capturing images of a movable object in a scene and tracking movement of the object in the scene based on the images, to produce movement parameters that define the movement; generating for display an extended reality (XR) visualization of the physical object in the scene and changing the XR visualization responsive to changing ones of the movement parameters, such that the XR visualization visually reflects the tracked movement; and converting the movement parameters to control messages configured to control one or more of sound and light, and transmitting the control messages.

In yet another aspect, a non-transitory computer readable medium encoded with instructions is provided. The instructions, when executed by a controller, cause the controller to: receive images of a movable object in a scene captured by a camera; track movement of the object in the scene based on the images; and generate for display an extended reality (XR) visualization of the physical object in the scene and changes to the XR visualization responsive to the tracked movement; convert the tracked movement to control messages configured to control one or more of sound and light; and transmit the control messages.

In yet another aspect, a non-transitory computer readable medium encoded with instructions is provided. The instructions, when executed by a controller, cause the controller to: receive images of a primary physical object captured by a camera; track a position of the primary physical object based on the images; generate for display an extended reality (XR) visualization for the primary physical object responsive to the tracked position; receive from a secondary physical object movement signals indicative of movement of the secondary physical object; convert the movement signals to control messages configured to control one or more of sound, light, and the XR visualization; and transmit the control messages to control the one or more of the sound, the light, and the XR visuals.

The above description is intended by way of example only. The description is not intended to be exhaustive nor is the invention intended to be limited to the disclosed example embodiment(s). Many modifications and variations will be apparent to those of ordinary skill in the art without departing from the scope and spirit of the invention.

What is claimed is:

1. A method comprising:
capturing images of a movable object in a scene and tracking movement of the object in the scene based on the images, to produce movement parameters that define the movement;
generating for display an extended reality (XR) visualization of the physical object in the scene and changing the XR visualization responsive to changing ones of the movement parameters, such that the XR visualization visually reflects the tracked movement;
displaying the XR visualization; and
converting the movement parameters to control messages configured to control one or more of sound and light, and transmitting the control messages.

2. The method of claim 1 wherein:
the generating the XR visualization and the changing the XR visualization includes generating an animated overlay representative of the object and changing visual features of the animated overlay responsive to the changing ones of the movement parameters.

3. The method of claim 2, wherein:
the changing the visual features includes changing between different sizes, shapes, or colors of the animated overlay responsive to the changing ones of the movement parameters.

4. The method of claim 1, wherein:
the converting includes converting the movement parameters to sound control messages configured to control sound; and
the transmitting includes transmitting the sound control messages to a sound controller configured to control sound responsive to the sound control messages.

5. The method of claim 4, wherein the sound control messages include Musical Instrument Digital Interface (MIDI) or Open Sound Control (OSC) messages.

6. The method of claim 1, wherein:
the converting including converting the movement parameters to light control messages configured to control light responsive to the movement; and
the transmitting includes transmitting the light control messages to a light controller configured to control light responsive to the light control messages.

7. The method of claim 6, wherein the light control messages include digital multiplex (DMX) messages.

8. The method of claim 1, further comprising:
receiving messages indicating sound attributes;
converting the sound attributes to control messages configured for changing the XR visualization; and
further changing the XR visualization responsive to the control messages configured for changing the XR visualization.

9. The method of claim 1, wherein:
the tracking the movement includes tracking a 3-dimensional (3D) position and a rotation of the object, to produce 3D position parameters and one or more rotation parameters; and
the changing the XR visualization includes changing the XR visualization responsive to changing ones of the 3D position parameters and the one or more rotation parameters; and
the converting includes converting one or more of the 3D position parameters and the one or more rotation parameters to corresponding ones of the control messages configured to control the one or more of the sound and the light.

10. The method of claim 1, further comprising:
displaying a user interface configured to present user selectable options for mapping the movement parameters to the corresponding ones of the different sound control messages; and
upon receiving selections of the selectable options, mapping the movement parameters to corresponding ones of the control messages in accordance with the selections,
wherein the converting includes converting the movement parameters to the control messages in accordance with the mappings.

11. The method of claim 1, further comprising:
receiving movement signals indicative of movement of a secondary moveable object;
converting the movement signals to further control messages configured to control one or more of the XR visualization, the sound, and the light;
controlling one or more of the XR visualization, the sound, and the light responsive to the further control messages.

12. The method of claim 1, further comprising:
receiving, from sensors of a sensored glove for a human hand, hand movement signals indicative of movement of the glove;
converting the hand movement signals to control messages configured for changing the XR visualization; and
changing the XR visualization responsive to the control messages configured for changing the XR visualization.

13. The method of claim 12, further comprising:
converting the hand movement signals to sound control messages configured to control sound responsive to the movement of the glove; and
transmitting the sound control messages.

14. The method of claim 1, further comprising:
defining as an event trigger a predetermined position for the object in a 3-dimensional space; and
upon detecting, based on the tracking, that the movement of the object coincides with the predetermined position, triggering generation of sound control messages and transmitting the sound control messages.

15. A system comprising:
an extended reality (XR) controller including:
a camera to capture images of a movable object in a scene;
a controller coupled to the video camera and configured to:
track movement of the object in the scene based on the images; and
generate for display an extended reality (XR) visualization of the physical object in the scene and changes to the XR visualization responsive to the tracked movement; and
a display coupled to the camera and the controller and configured to display the XR visualization; and
a bridge coupled to the controller and configured to:
convert the tracked movement to control messages configured to control one or more of sound and light; and
transmit the control messages.

16. The system of claim 15, wherein the bridge is configured to:
convert by converting the tracked movement to sound control messages configured to control sound; and
transmit by transmitting the sound control messages to a sound controller configured to control sound responsive to the sound control messages.

17. The system of claim 16, wherein:
the bridge is configured to:
receive from the sound controller messages indicating sound attributes; and
convert the sound attributes to control messages configured for changing the XR visualization; and
the XR controller is configured to change the XR visualization responsive to the control messages configured for changing the XR visualization.

18. The system of claim 16, further comprising:
a sensored glove configured to be worn by a human hand, convert hand movement to hand movement signals, and transmit the hand movement signals,
wherein the bridge is configured to receive the hand movement signals and convert the hand movement signals to second control messages configured for changing the XR visualization, and
wherein the XR controller is configured to change the XR visualization responsive to the second control messages configured for changing the XR visualization.

19. The system of claim 16, wherein:
the bridge is configured to convert the hand movement signals from the sensored glove to second sound control messages, and transmit the second sound control messages to the sound controller.

20. A system comprising:
an extended reality (XR) controller including:
a camera to capture images of a primary physical object;
a controller coupled to the video camera and configured to:
track a position of the primary physical object based on the images; and
generate for display an extended reality (XR) visualization for the primary physical object responsive to the tracked position; and
a display coupled to the camera and the controller and configured to display the XR visualization; and
a bridge coupled to the XR controller and configured to:
receive from a secondary physical object movement signals indicative of movement of the secondary physical object; and
convert the movement signals to control messages configured to control one or more of sound, light, and the XR visualization; and
transmit the control messages to control the one or more of the sound, the light, and the XR visuals.

21. The system of claim 20, further comprising as the secondary physical object a sensored physical object including sensors configured to convert movement of the secondary physical object to the movement signals, and to transmit the movement signals.

22. The system of claim 20, further comprising a second XR controller including:
a camera to capture images of the secondary physical object;
a controller coupled to the video camera and configured to:
track movement of the secondary physical object based on the images, to produce the movement signals as representative of the tracked movement; and
transmit the movement signals.

23. The system of claim 20, wherein the bridge is further configured to:
receive from a digital audio workstation messages indicating sound attributes; and
convert the sound attributes to further control messages configured to control one or more of the XR visualization and the light, and transmit the further control messages to control the one or more of the XR visualization and the light.
